(19) United States
(12) Patent Application Publication
(10) Pub. No.: US 2023/0224130 A1
(43) Pub. Date: Jul. 13, 2023

(54) CONTROL RESOURCE SET TYPE CONFIGURATIONS

(71) Applicant: QUALCOMM Incorporated, San Diego, CA (US)

(72) Inventors: Tianyang BAI, Somerville, NJ (US); Yan ZHOU, San Diego, CA (US); Junyi LI, Fairless Hills, PA (US); Tao LUO, San Diego, CA (US)

(21) Appl. No.: 18/064,679

(22) Filed: Dec. 12, 2022

Related U.S. Application Data
(60) Provisional application No. 63/266,544, filed on Jan. 7, 2022.

(51) Int. Cl. H04L 5/00; H04W 72/23

(52) U.S. Cl. CPC H04L 5/0053; H04W 72/23

(57) ABSTRACT

Various aspects of the present disclosure generally relate to wireless communication. In some aspects, a user equipment (UE) may receive an indication of a control resource set (CORESET) configuration that indicates one or more allowed CORESET types, of a set of possible CORESET types, associated with control channel reception, wherein the set of possible CORESET types includes: a CORESET type 0, a CORESET type A, a CORESET type B, and a CORESET type C. The UE may monitor at least one search space associated with at least one CORESET based at least in part on the CORESET configuration. Numerous other aspects are described.

### CROSS-REFERENCE TO RELATED APPLICATION

This patent application claims priority to U.S. Provisional Patent Application No. 63/266,544, filed on Jan. 7, 2022, entitled “CONTROL RESOURCE SET TYPE CONFIGURATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for control resource set type configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example resource structure for wireless communication, in accordance with the present disclosure.

FIG. 4 is a diagram illustrating an example associated with control resource set (CORESET) type configurations, in accordance with the present disclosure.

FIGS. 5-8 are diagrams illustrating example processes associated with CORESET type configurations, in accordance with the present disclosure.

FIGS. 9 and 10 are diagrams of example apparatuses for wireless communication, in accordance with the present disclosure.

FIG. 11 is a diagram illustrating a disaggregated base station architecture, in accordance with the present disclosure.

### SUMMARY

Some aspects described herein relate to a method of wireless communication performed by a user equipment (UE). The method may include receiving an indication of a control resource set (CORESET) configuration that indicates one or more allowed CORESET types, of a set of possible CORESET types, associated with control channel reception corresponding to a component carrier, wherein the set of possible CORESET types comprises, a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The method may include monitoring at least one search space associated with at least one CORESET based at least in part on the CORESET configuration.

Some aspects described herein relate to a method of wireless communication performed by a UE. The method may include receiving an indication of a CORESET configuration of a type 0 CORESET associated with initial network access, wherein the type 0 CORESET is quasi co-located with an initial access reference signal based at least in part on an initial transmission configuration indicator (TCI) state, wherein the initial access reference signal comprises a master information block. The method may include monitoring at least one search space associated with the type 0 CORESET based at least in part on the initial TCI state.

Some aspects described herein relate to a method of wireless communication performed by a network node. The method may include transmitting an indication of a CORESET configuration that indicates one or more allowed CORESET types, of a set of possible CORESET types, associated with control channel reception corresponding to a component carrier, wherein the set of possible CORESET types comprises a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The method may include transmitting at least one control channel communication in at least one search space associated with at least one CORESET based at least in part on the CORESET configuration.

Some aspects described herein relate to a method of wireless communication performed by a network node. The method may include transmitting an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The method may include transmitting at least one control channel communication in at least one search space associated with the type 0 CORESET based at least in part on the initial TCI state.

Some aspects described herein relate to a UE for wireless communication. The UE may include a memory and one or more processors coupled to the memory. The one or more processors may be configured to receive an indication of a CORESET configuration that indicates one or more allowed CORESET types, of a set of possible CORESET types, associated with control channel reception corresponding to a component carrier, wherein the set of possible CORESET types comprises a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The one or more processors may be configured to monitor at least one search space associated with at least one CORESET based at least in part on the CORESET configuration.

Some aspects described herein relate to a UE for wireless communication. The UE may include a memory and one or more processors coupled to the memory. The one or more processors may be configured to receive an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The one or more processors may be configured to monitor at least one search space associated with the type 0 CORESET based at least in part on the initial TCI state.

Some aspects described herein relate to a network node for wireless communication. The network node may include a memory and one or more processors coupled to the memory. The one or more processors may be configured to transmit an indication of a CORESET configuration that indicates one or more allowed CORESET types, of a set of possible CORESET types, associated with control channel reception corresponding to a component carrier, wherein the set of possible CORESET types comprises a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The one or more processors may be configured to transmit at least one control channel communication in at least one search space associated with at least one CORESET based at least in part on the CORESET configuration.

Some aspects described herein relate to a network node for wireless communication. The network node may include a memory and one or more processors coupled to the memory. The one or more processors may be configured to transmit an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The one or more processors may be configured to transmit at least one control channel communication in at least one search space associated with the type 0 CORESET based at least in part on the initial TCI state.

Some aspects described herein relate to a non-transitory computer-readable medium that stores a set of instructions for wireless communication by a UE. The set of instructions, when executed by one or more processors of the UE, may cause the UE to receive an indication of a CORESET configuration that indicates one or more allowed CORESET types, of a set of possible CORESET types, associated with control channel reception corresponding to a component carrier, wherein the set of possible CORESET types comprises a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The set of instructions, when executed by one or more processors of the UE, may cause the UE to monitor at least one search space associated with at least one CORESET based at least in part on the CORESET configuration.

Some aspects described herein relate to a non-transitory computer-readable medium that stores a set of instructions for wireless communication by an UE. The set of instructions, when executed by one or more processors of the UE, may cause the UE to receive an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The set of instructions, when executed by one or more processors of the UE, may cause the UE to monitor at least one search space associated with the type 0 CORESET based at least in part on the initial TCI state.

Some aspects described herein relate to a non-transitory computer-readable medium that stores a set of instructions for wireless communication by a network node. The set of instructions, when executed by one or more processors of the network node, may cause the network node to transmit an indication of a CORESET configuration that indicates one or more allowed CORESET types, of a set of possible CORESET types, associated with control channel reception corresponding to a component carrier, wherein the set of possible CORESET types comprises a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The set of instructions, when executed by one or more processors of the network node, may cause the network node to transmit at least one control channel communication in at least one search space associated with at least one CORESET based at least in part on the CORESET configuration.

Some aspects described herein relate to a non-transitory computer-readable medium that stores a set of instructions for wireless communication by a network node. The set of instructions, when executed by one or more processors of the network node, may cause the network node to transmit an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The set of instructions, when executed by one or more processors of the network node, may cause the network node to transmit at least one control channel communication in at least one search space associated with the type 0 CORESET based at least in part on the initial TCI state.

Some aspects described herein relate to an apparatus for wireless communication. The apparatus may include means for receiving an indication of a CORESET configuration that indicates one or more allowed CORESET types, of a set of possible CORESET types, associated with control channel reception corresponding to a component carrier, wherein the set of possible CORESET types comprises, a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The apparatus may include means for monitoring at least one search space associated with at least one CORESET based at least in part on the CORESET configuration.

Some aspects described herein relate to an apparatus for wireless communication. The apparatus may include means for receiving an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The apparatus may include means for monitoring at least one search space associated with the type 0 CORESET based at least in part on the initial TCI state.

Some aspects described herein relate to an apparatus for wireless communication. The apparatus may include means for transmitting an indication of a CORESET configuration that indicates one or more allowed CORESET types, of a set of possible CORESET types, associated with control channel reception corresponding to a component carrier, wherein the set of possible CORESET types comprises, a CORESET type 0, where a CORESET having the CORESET type 0 is associated with initial network access; a CORESET type A, where a CORESET having the CORESET type A is only associated with UE-dedicated control channel reception; a CORESET type B, where a CORESET having the CORESET type B is only associated with non-UE-dedicated control channel reception; and a CORESET type C, where a CORESET having the CORESET type C is associated with UE-dedicated control channel reception and non-UE-dedicated control channel reception. The apparatus may include means for transmitting at least one control channel communication in at least one search space associated with at least one CORESET based at least in part on the CORESET configuration.

Some aspects described herein relate to an apparatus for wireless communication. The apparatus may include means for transmitting an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The apparatus may include means for transmitting at least one control channel communication in at least one search space associated with the type 0 CORESET based at least in part on the initial TCI state.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

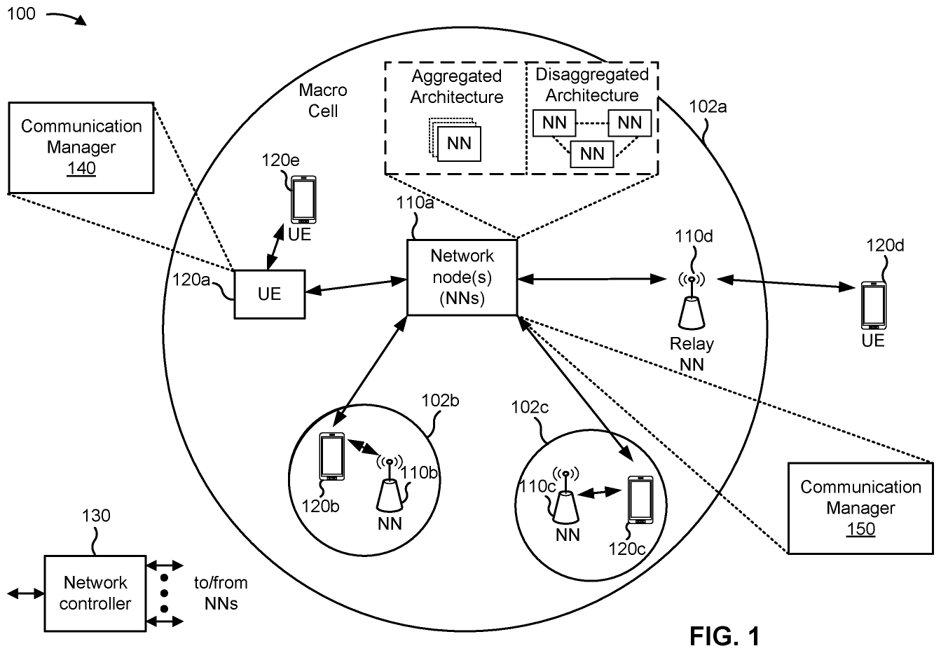

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a control resource set (CORESET) configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception; and monitor at least one search space associated with at least one CORESET based at least in part on the CORESET configuration. Additionally, or alternatively, the communication manager 140 may perform one or more other operations described herein.

In some aspects, the communication manager 140 may receive an indication of a CORESET configuration of a type 0 CORESET associated with initial network access, wherein the type 0 CORESET is quasi co-located with an initial access reference signal based at least in part on an initial transmission configuration indicator (TCI) state, wherein the initial access reference signal comprises a master information block; and monitor at least one search space associated with the type 0 CORESET based at least in part on the initial TCI state. Additionally, or alternatively, the communication manager 140 may perform one or more other operations described herein.

In some aspects, the network node 110 may include a communication manager 150. As described in more detail elsewhere herein, the communication manager 150 may transmit an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception; and transmit at least one control channel communication in at least one search space associated with at least one CORESET based at least in part on the CORESET configuration. Additionally, or alternatively, the communication manager 150 may perform one or more other operations described herein.

In some aspects, the communication manager 150 may transmit an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block; and transmit at least one control channel communication in at least one search space associated with the type 0 CORESET based at least in part on the initial TCI state. Additionally, or alternatively, the communication manager 150 may perform one or more other operations described herein.

As indicated above, FIG. 1 is provided as an example. Other examples may differ from what is described with regard to FIG. 1.

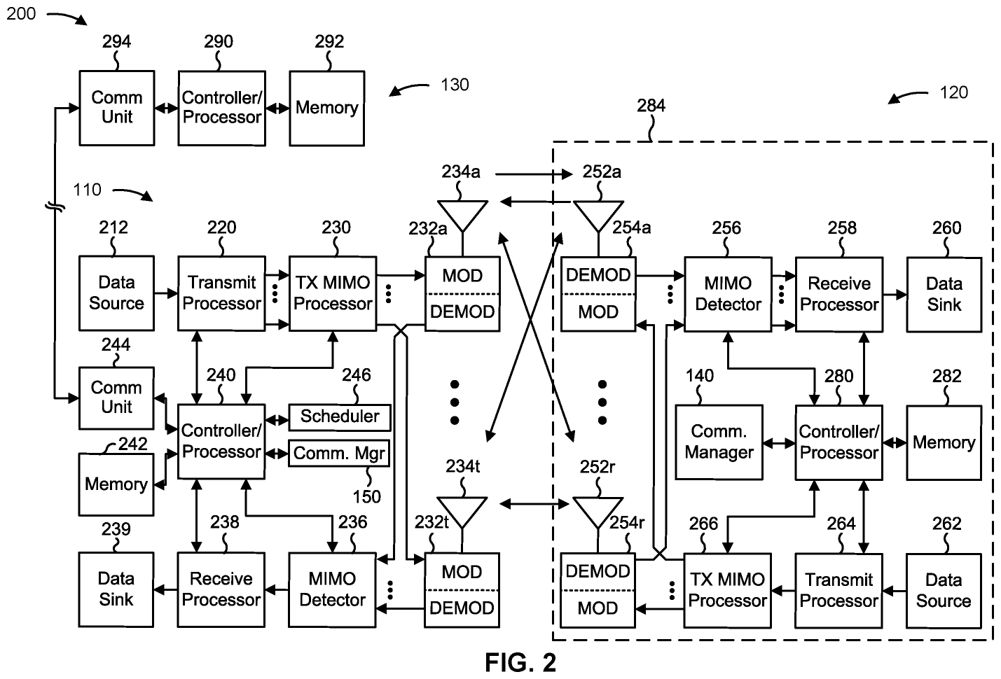

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of TCI states that respectively indicate beams that may be used by the UE, such as for receiving a physical downlink control channel (PDCCH) and/or physical downlink shared channel (PDSCH). The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

Some UEs and/or network nodes may support full duplex operation in which the UEs and/or the network nodes support full duplex operations. For example, a UE may support transmission via a first beam (e.g., using a first antenna panel) and may simultaneously support reception via a second beam (e.g., using a second antenna panel). Support for simultaneous transmission and reception may be conditional on beam separation, such as spatial separation (e.g., using different beams), frequency separation, and/or the like. Additionally, or alternatively, support for simultaneous transmission may be conditional on using beamforming (e.g., in frequency range 2 (FR2), in frequency range 4 (FR4), for millimeter wave signals, and/or the like).

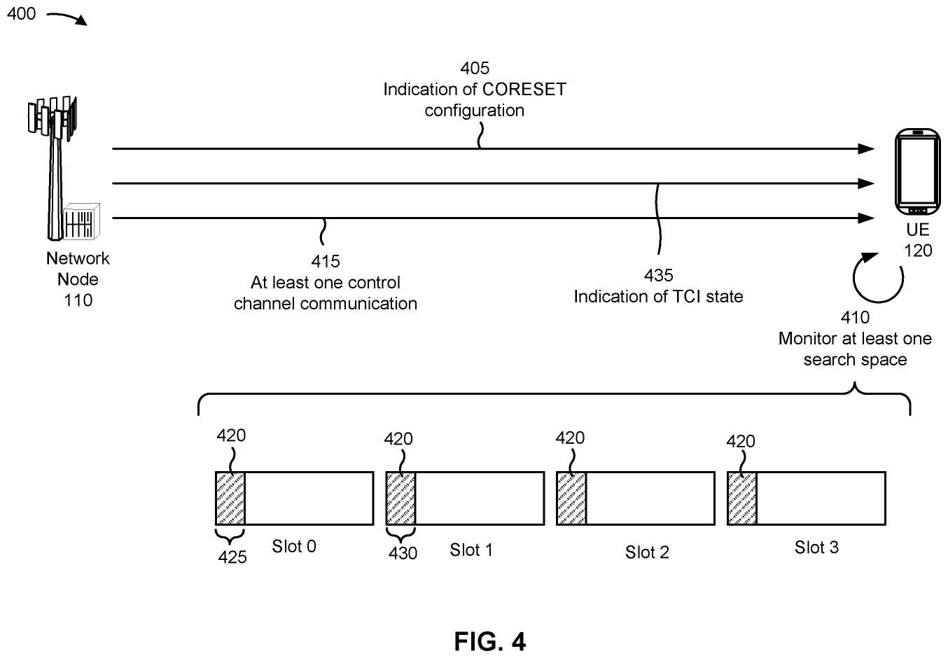

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

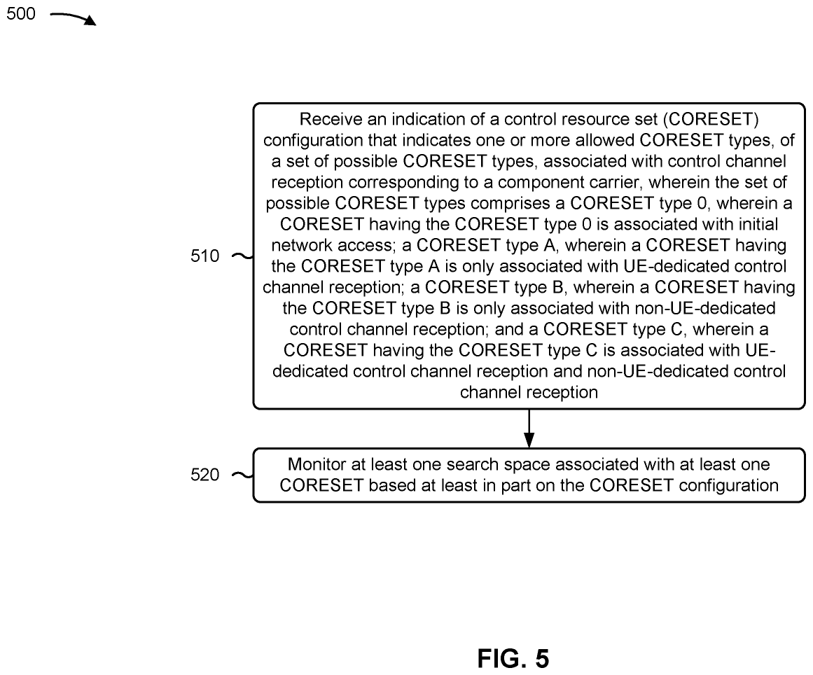

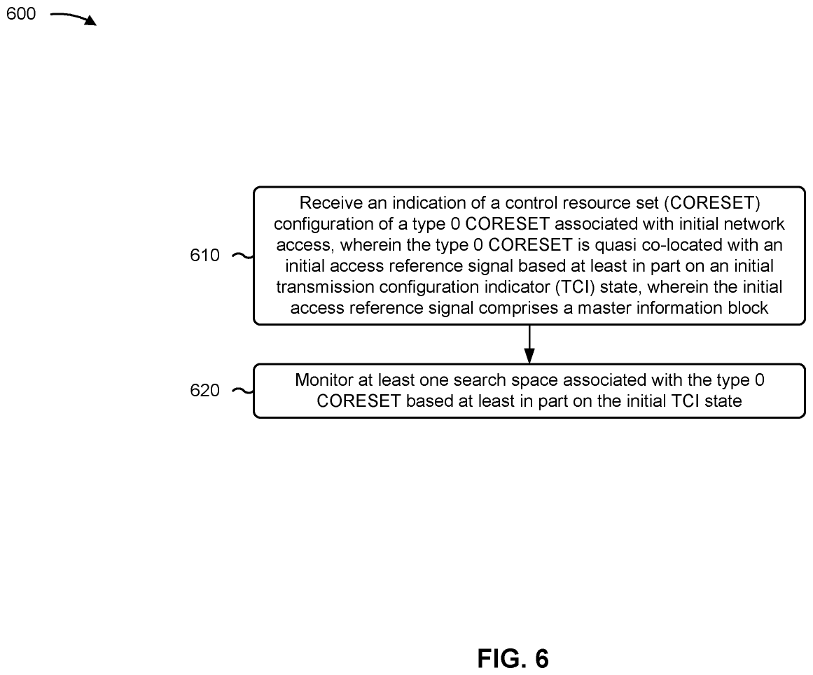

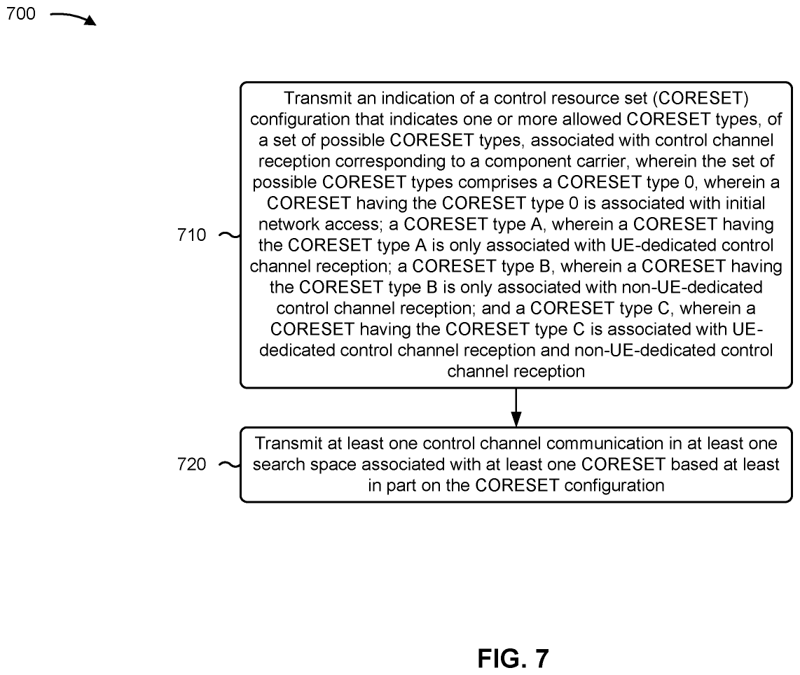

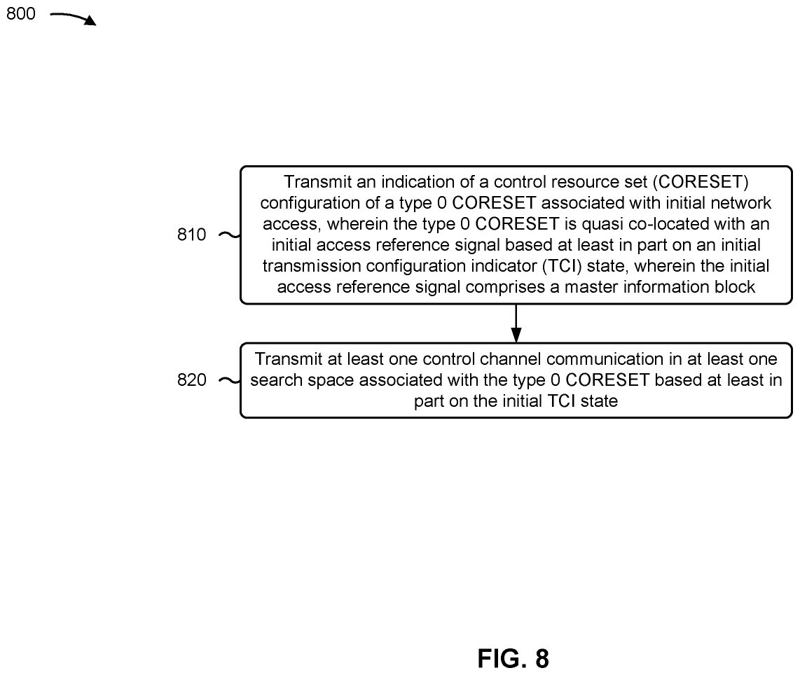

The controller/processor 240 of the network node 110, the controller/processor 280 of the UE 120, and/or any other component(s) of FIG. 2 may perform one or more techniques associated with CORESET type configurations, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5, process 600 of FIG. 6, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5, process 600 of FIG. 6, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for receiving an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and/or a CORESET type C, wherein a CORESET having the CORESET type C is associated with UE-dedicated control channel reception and non-UE-dedicated control channel reception; and/or means for monitoring at least one search space associated with at least one CORESET based at least in part on the CORESET configuration.

In some aspects, the UE includes means for receiving an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block; and/or means for monitoring at least one search space associated with the type 0 CORESET based at least in part on the initial TCI state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and/or a CORESET type C, wherein a CORESET having the CORESET type C is associated with UE-dedicated control channel reception and non-UE-dedicated control channel reception; and/or means for transmitting at least one control channel communication in at least one search space associated with at least one CORESET based at least in part on the CORESET configuration.

In some aspects, a network node (e.g., the network node 110) includes means for transmitting an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block; and/or means for transmitting at least one control channel communication in at least one search space associated with the type 0 CORESET based at least in part on the initial TCI state. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

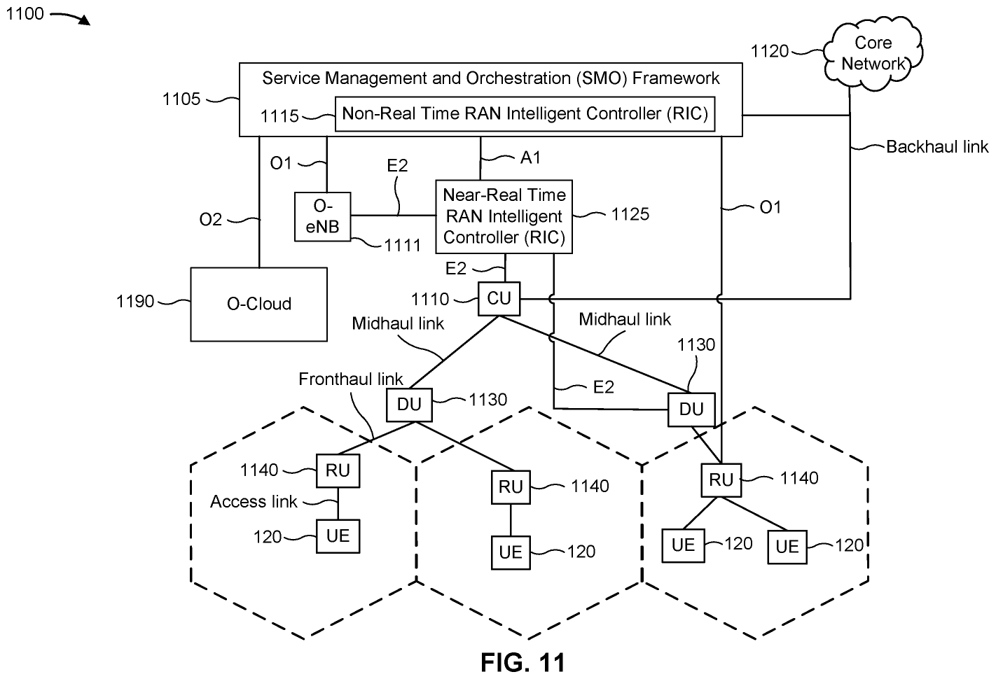

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station. Further details of the disaggregated base station are described in connection with FIG. 11.

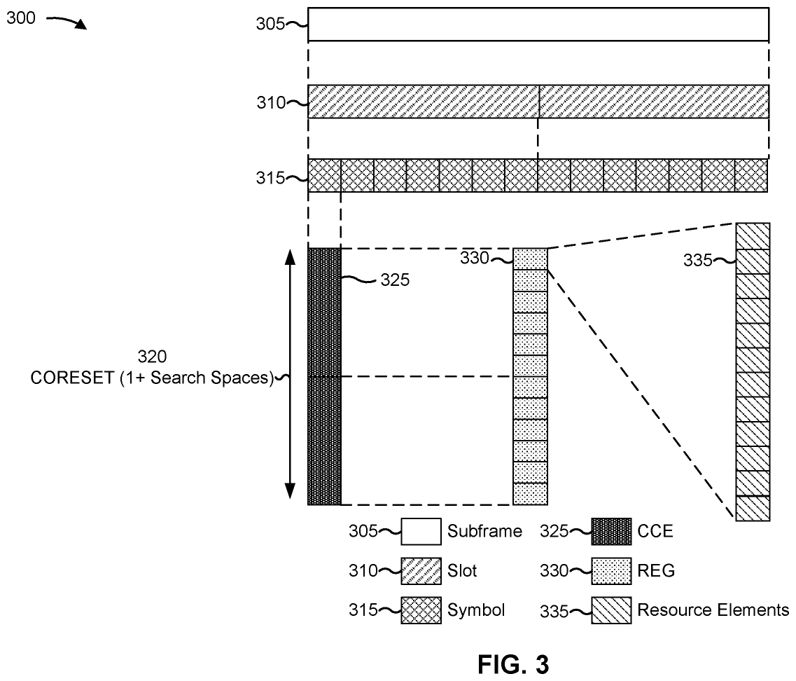

FIG. 3 is a diagram illustrating an example resource structure 300 for wireless communication, in accordance with the present disclosure. The resource structure 300 shows an example of various groups of resources described herein. As shown, the resource structure 300 includes a subframe 305. The subframe 305 includes multiple slots 310. While the resource structure 300 is shown as including 2 slots per subframe, a different number of slots can be included in a subframe (e.g., 4 slots, 8 slots, 16 slots, 32 slots, or another quantity of slots). In some cases, different types of transmission time intervals (TTIs) can be used, other than subframes and/or slots. A slot 310 can include multiple symbols 315, such as 14 symbols per slot.

The potential control region of a slot 310 can be referred to as a CORESET 320 and can be structured to support an efficient use of resources, such as by flexible configuration or reconfiguration of resources of the CORESET 320 for one or more PDCCHs and/or one or more PDSCHs. In some cases, the CORESET 320 can occupy the first symbol 315 of a slot 310, the first two symbols 315 of a slot 310, or the first three symbols 315 of a slot 310. Thus, a CORESET 320 can include multiple resource blocks (RBs) in the frequency domain, and one, two, or three symbols 315 in the time domain. In some cases, a CORESET 320 can be configured to occupy more than three symbols 315 in the time domain. In 5G, a quantity of resources included in the CORESET 320 can be flexibly configured, such as by using radio resource control (RRC) signaling to indicate a frequency domain region (e.g., a quantity of resource blocks) and/or a time domain region (e.g., a quantity of symbols) for the CORESET 320.

As illustrated, a symbol 315 that includes the CORESET 320 can include one or more control channel elements (CCEs) 325, shown as two CCEs 325 as an example, that span a portion of the system bandwidth. A CCE 325 can include DCI that is used to provide control information for wireless communication. A network node can transmit DCI during multiple CCEs 325 (as shown), where the quantity of CCEs 325 used for transmission of DCI represents the aggregation level (AL) used by the network node for the transmission of DCI. In FIG. 3, an aggregation level of two is shown as an example, corresponding to two CCEs 325 in a slot 310. In some cases, different aggregation levels can be used, such as 1, 2, 4, 8, 16, or another aggregation level.

Each CCE 325 can include a fixed quantity of resource element groups (REGs) 330, shown as 6 REGs 330, or can include a variable quantity of REGs 330. In some cases, the quantity of REGs 330 included in a CCE 325 can be specified by a REG bundle size. A REG 330 can include one resource block, which can include 12 resource elements (REs) 335 within a symbol 315. A resource element 335 can be defined to occupy one subcarrier in the frequency domain and one OFDM symbol in the time domain. In some cases, a resource element 335 can be defined to occupy something other than one subcarrier in the frequency domain and/or something other than one OFDM symbol in the time domain.

A search space is a set of CCEs containing PDCCH candidates for a UE to monitor. A PDCCH candidate is a CCE location or CCE locations where a UE may find one or more PDCCHs that can potentially be used to transmit control information to the UE. In some cases, a search space is the set of all PDCCH candidates at an aggregation level. A UE performs blind decoding of the PDCCH candidates. A search space can be configured to be associated with a CORESET 320. For example, a CORESET 320 can include one or more search spaces. A search space can include a UE-dedicated search space (e.g., a UE-specific search space (USS)) or a non-UE-dedicated search space (e.g., a group-common search space and/or a common search space (CSS)).

A wireless communication standard can specify a number of different types of non-UE-dedicated search spaces. For example, a non-UE-dedicated search space can be a type 0 search space (sometimes referred to as a “type 0 PDCCH CSS”), which can be configured for reception of a system information block (SIB) by a UE. For example, a UE can receive a certain type of SIB, a SIB1, in a type 0 search space. The SIB1 provides the UE with scheduling information for all other system information. A non-UE-dedicated search space can be a type OA search space, which can be configured for reception, by a UE, of other system information. A non-UE-dedicated search space can be a type 1 search space, which can be configured for reception, by a UE, of PDCCH communications during a random access channel (RACH) procedure. A non-UE-dedicated search space can be a type 2 search space, which can be configured for reception, by a UE, of PDCCH communications for paging. A non-UE-dedicated search space can be a type 3 search space, which can be used for UE group operations (e.g., slot format indication and/or group power control associated with uplink channels, among other examples).

In some cases, a non-UE-dedicated search space can carry UE specific PDCCH communications. UE-dedicated search spaces can be configured by RRC messages and can be used for reception, by a UE, of UE-specific PDCCH communications. In some cases, a type 0 search space, which may be referred to as a search space 0, can be used to schedule PDSCH communications carrying SIB1 during initial access of a network by a UE. The search space 0 can be configured by a parameter, pdsch-configuSIB1, in a master information block (MIB) of a physical broadcast channel (PBCH). The search space 0 is associated with a type 0 CORESET (which may be referred to as a CORESET 0). The CORESET 0 also is configured in the MIB, such that a UE can obtain the CORESET 0 configuration by receiving PBCH communications.

The possible locations for a PDCCH can depend on whether the PDCCH is a UE-dedicated PDCCH (e.g., for a single UE) or a group-common PDCCH (e.g., for multiple UEs) and/or an aggregation level being used. For example, the set of all possible PDCCH locations for a UE can be referred to as a USS. Similarly, the set of all possible PDCCH locations across multiple UEs can be referred to as a CSS. The set of all possible PDCCH locations for a group of UEs can be referred to as a group-common search space. One or more search spaces across aggregation levels can be referred to as a search space (SS) set. In some cases, a configuration of a search space can include, for example, aggregation level, DCI formats, PDCCH decoding candidates, and/or PDCCH monitoring occasions, among other examples. A PDCCH monitoring occasion is an occasion (e.g., time period) during which a UE is configured to blind decode a PDCCH in a search space.

In some cases, a TCI state can be configured with (e.g., associated with) a CORESET 320. In general, the TCI state of any CORESET can be updated by a medium access control control element (MAC CE). Before RRC configuration, a UE needs to know the TCI state of the CORESET 0 to receive the PDCCH associated with the SIB1. In this case, the CORESET 0 TCI state corresponds to the TCI state of the synchronization signal block (SSB) that provides the MIB (which provides the CORESET 0 configuration). After RRC configuration, the TCI state of CORESET 0 can be updated by MAC CE. For example, the TCI state of CORESET 0 can correspond to the TCI state of the SSB that is quasi co-located with an indicated channel state information reference signal (CSI-RS) in a MAC CE. In some cases, after a contention free RACH (CFRA) procedure not initialized by a PDCCH order (e.g., a CFRA procedure initiated as a result of a primary cell beam failure recovery operation), the TCI state of CORESET 0 can correspond to the SSB used in the RACH procedure.

In some cases, a unified TCI framework may be implemented in which a common TCI state can be used for multiple signals and/or channels simultaneously. In some cases, a unified TCI state can be used separately for downlink or uplink, or jointly for downlink and uplink. A unified downlink and/or joint TCI state can be indicated to a UE using a DCI transmission having DCI format 1_1 or 1_2. The downlink or joint TCI state can be used for UE-dedicated PDSCH and UE-dedicated CORESETs. In some cases, non-UE-dedicated PDSCHs and non-UE-dedicated CORESETs can be configured by RRC signaling to follow the same TCI state as a UE-dedicated PDSCH and/or a UE-dedicated CORESET. In cases, in which TCI states are not shared, the TCI state can be based on a serving cell SSB and/or a serving cell CSI-RS (e.g., in an intracell beam management case). A unified TCI state can use, as a source reference signal, a non-serving cell SSB or a CSI-RS whose root QCL reference signal is a non-serving cell SSB (e.g., in an intercell beam management case). For example, a TCI state of a first reference signal (RS1) can determine a TCI state of a second reference signal (RS2), which can determine a TCI state of a non-serving cell SSB.

In a unified TCI framework, an indicated TCI state can be applied to PDCCH reception and the corresponding PDSCH reception according to a number of different rules, which can be based on CORESET types. A CORESET can be one of a number of different CORESET types. For example, a type A CORESET is a CORESET having a CORESET type A and can be defined as a CORESET, other than a type 0 CORESET, that is associated only with UE-dedicated reception on PDCCH in a specified component carrier. A type A CORESET can be associated with USSs and/or type 3 search spaces (e.g., a type 3 CSSs). A type B CORESET is a CORESET having a CORESET type B and can be defined as a CORESET, other than a type 0 CORESET, that is associated only with non-UE-dedicated reception on PDCCH in a component carrier. A type B CORESET can be associated with a CSS or a type 3 search space (e.g., a type 3 CSS). A type C CORESET is a CORESET having a CORESET type C and can be defined as a CORESET, other than a type 0 CORESET, that is associated with both UE-dedicated and non-UE-dedicated reception on PDCCH in a component carrier. A type 0 CORESET is a CORESET having a CORESET type 0 and can be defined as a CORESET associated with initial access. Although four examples of CORESET types are described herein, a CORESET can be of any additional type in lieu of, or in addition to, one of the four types discussed herein.

A wireless communication standard can define rules for application of a unified TCI framework associated with the different types of CORESETs. For example, in some cases, for any PDCCH reception on a type A CORESET and the corresponding PDSCH reception, a UE can be configured to apply an indicated TCI state. An indicated TCI state is a TCI state indicated in DCI. The indicated TCI state can be used for applicable channels until a subsequent TCI indication is received. For any PDCCH reception on a type B CORESET and the corresponding PDSCH reception, whether or not the UE is to apply the indicated TCI state associated with the serving cell can be determined per CORESET by RRC signaling. In some cases, if the UE is configured to not apply the indicated TCI state, the TCI state of the CORESET can be indicated by a MAC CE.

Many network architectures and frameworks allow for both UE-dedicated signaling non-UE-dedicated signaling. Because type A CORESETs are associated only with UE-dedicated reception and type B CORESETs are associated with only non-UE-dedicated reception, CORESETs of both types often are configured, which can reduce network efficiency, increase network signaling overhead (e.g., configuration signaling), and consumption of UE resources for additional blind decoding. Allowing for applicability of type C CORESETs can facilitate improved efficiency, reduction of network signaling overhead, and reduction of UE resource consumption for blind decoding because a type C CORESET can be associated with both UE-dedicated and non-UE-dedicated reception in PDCCH. However, in some cases, type A CORESETs and/or type B CORESETs may be more efficient due to the nature of the communication. Without a standard for determining whether to allow type C CORESET configuration and, if type C CORESETs are allowed, how to determine corresponding TCI states, UEs and networks cannot take advantage of the potential efficiencies of implantation. Moreover, without being able to determine a TCI state for a type 0 CORESET, a UE can encounter difficulties with network access.

Some aspects of techniques and apparatuses described herein may provide a framework for facilitating type C CORESET configuration, determination of TCI states associated with type C CORESETs, and/or determination of TCI states for type 0 CORESETs. In this way, some aspects of the techniques and/or apparatuses described herein may have a positive impact on network performance by facilitating improved efficiency, reduction of network signaling overhead, and reduction of UE resource consumption for blind decoding.

As indicated above, FIG. 3 is provided as an example. Other examples may differ from what is described with regard to FIG. 3.

FIG. 4 is a diagram illustrating an example 400 associated with CORESET type configurations, in accordance with the present disclosure. As shown in FIG. 4, a network node 110 and a UE 120 may communicate with one another.

As shown by reference number 405, the network node 110 may transmit, and the UE 120 may receive, an indication of a CORESET configuration. In some aspects, the CORESET configuration may indicate one or more allowed CORESET types, of a set of possible CORESET types, associated with control channel reception corresponding to a component carrier. The set of possible CORESET types may include, for example, a CORESET type 0, a CORESET type A, a CORESET type B, and a CORESET type C. In some aspects, the set of possible CORESET types may include any subset of these and/or additional types of CORESETs. As shown by reference number 410, the UE 120 may monitor at least one search space associated with at least one CORESET based at least in part on the CORESET configuration.

As shown by reference number 415, the network node 110 may transmit, and the UE 120 may receive, at least one control channel communication based at least in part on the CORESET configuration. As shown, for example, a number of slots (shown as “slot 0,” “slot 1,” “slot 2,” and “slot 3”) may each include a CORESET 420 and one or more search spaces may be associated with each CORESET 420. The UE 120 may monitor one search space in a first monitoring occasion 425, two search spaces in a second monitoring occasion 430, and so on. The CORESET configuration may correspond to one of an intercell beam management configuration or an intracell beam management configuration. In some aspects, for example, the network node 110 may transmit, and the UE 120 may receive, an indication of an additional CORESET configuration that corresponds to the other one of the intercell beam management configuration or the intracell beam management configuration.

In some aspects, for example, a type C CORESET may be not allowed (e.g., a CORSET is either a type 0 CORESET, a type A CORESET, or a type B CORESET). For example, in this case, a CORESET (except for a type 0 CORESET) can be associated with all UE-dedicated search spaces or all non-UE-dedicated search spaces. In some aspects, a type C CORESET may be allowed, but the allowance thereof may be conditioned on a rule that specifies that in the same monitoring occasion of a Type C CORESET, the UE 120 only monitors one type of search space (either UE-dedicated search spaces or non-UE-dedicated search spaces). For example, the one or more allowed CORESET types may include the CORESET type C, and the at least one search space may be associated with a type C CORESET of the at least one CORESET, and monitoring the at least one search space may include monitoring, in a monitoring occasion of the type C CORESET, one or more search spaces of the at least one search space, where all of the one or more search spaces are UE-dedicated search spaces or all of the one or more search spaces are non-UE-dedicated search spaces.

In some aspects, a type C CORESET may be allowed, and in the same monitoring occasion, the UE 120 can be configured to monitor both UE-dedicated and non-UE-dedicated search spaces. One or more rules may be defined to establish when the UE-dedicated search spaces and the non-UE-dedicated search spaces are associated with different TCI states.

In some aspects, for example, the determination of the TCI state to be associated with a type C CORESET may be a per-CORESET determination and may follow the rule of a UE-dedicated PDCCH. For example, for any PDCCH reception on a CORESET that is associated with at least a UE-dedicated search space and the corresponding PDSCH reception, the UE 120 may apply the indicated TCI state. As shown by reference number 435, the network node 110 may transmit, and the UE 120 may receive, an indication of an indicated TCI state corresponding to a type A CORESET. The type C CORESET may be associated with a UE-dedicated search space of the at least one search space, and monitoring the at least one search space may include monitoring the at least one search space based at least in part on a per-CORESET determination of a monitoring TCI state, where the monitoring TCI state is the indicated TCI state.

In some aspects, the per-CORESET determination may follow the same rule as a non-UE-dedicated search space. For example, in some aspects, for any PDCCH reception on a CORESET that is associated with at least a non-UE dedicated search space and the corresponding PDSCH reception, whether the UE 120 is to apply the indicated TCI state may be configured per CORESET by RRC signaling. For example, the UE 120 may receive, from the network node 110, a TCI configuration that indicates whether to apply the indicated TCI state.

In some aspects, the determination of the TCI state may include a per-monitoring occasion determination, and whether the non-UE-dedicated search space follows the indicated TCI state may be configured by RRC signaling per CORESET. For example, monitoring the at least one search space may include monitoring the at least one search space based at least in part on a per-monitoring occasion determination of a monitoring TCI state. In some aspects, if a non-UE-dedicated search space is configured to follow the indicated TCI state, then in all monitoring occasions, the CORESET may follow the indicated TCI state. In some aspects, if a non-UE-dedicated search space is configured to not follow the indicated TCI state, a set of per-monitoring occasion rules may indicate the monitoring TCI state. For example, in some monitoring occasions, the UE 120 may only monitor UE-dedicated search spaces and, in those monitoring occasions, the CORESET may be associated with the indicated TCI state. In some monitoring occasions, the UE 120 may only monitor non-UE dedicated search spaces and, in those monitoring occasions, the CORESET may be associated with an updated TCI state indicated in a MAC CE.

In some monitoring occasions, the UE 120 may monitor both UE-dedicated and non-UE-dedicated search spaces. In some aspects, the CORESET may be associated with the indicated TCI state, an updated TCI state, or a TCI state predefined based at least in part on at least one of a slot number or a search space configuration. For example, in some aspects, during each monitoring occasion, for any PDCCH reception on a CORESET that is associated with at least a UE-dedicated search space and the corresponding PDSCH reception, the UE 120 may apply the indicated TCI state. In some aspects, during each monitoring occasion, for any PDCCH reception on a CORESET that is not associated with any UE-dedicated search space and the corresponding PDSCH reception, whether the UE 120 is to apply the indicated TCI state may be configured per CORESET by RRC signaling.

In some aspects, the TCI state to be used may be determined using a per-monitoring occasion determination. The determination of whether the non-UE-dedicated search spaces are associated with the indicated TCI state may be configured, per search space, using RRC signaling. For example, in some aspects, if all non-UE-dedicated search spaces are configured to be associated with the indicated TCI state, then in all monitoring occasions, the CORESET may be associated with the indicated TCI state. If at least one non-UE-dedicated search space is configured to not be associated with the indicated TCI state, per-monitoring occasion rules may indicate the TCI state. For example, in some monitoring occasions, the UE may only monitor UE-dedicated search spaces and non-UE-dedicated search spaces that are configured to be associated with the indicated TCI state. In those monitoring occasions, the CORESET may be associated with the indicated TCI state. In some monitoring occasions, the UE 120 may monitor only non-UE-dedicated search spaces that are not associated with the indicated TCI state. In those monitoring occasions, the CORESET may be associated with an updated TCI state. In some monitoring occasions, the UE 120 may monitor UE-dedicated search spaces, non-UE-dedicated search spaces that are associated with the indicated TCI state, and non-UE-dedicated search spaces that are not associated with the indicated TCI state. In those cases, the CORESET may be associated with the indicated TCI state, an updated TCI state, or a TCI state that is based at least in part on at least one of a slot number or a search space configuration.

In some aspects, the type C CORESET may be allowed, but its allowance may be conditioned on a rule that specifies that non-UE-dedicated search spaces must be configured to share the same indicated TCI as the UE-dedicated CORESETs. In some aspects, whether to allow type C CORESETs may be determined separately for intercell beam management and intracell beam management. For example, type C CORESETs may be allowed for intercell beam management but not for intracell beam management (or vice-versa).

In some aspects, special rules may be specified in association with the type 0 CORESETs and/or type 0 search spaces. For example, in some aspects, the CORESET configuration may include a configuration of a type 0 CORESET associated with initial network access. The type 0 CORESET may be quasi co-located with an initial access reference signal based at least in part on an initial TCI state. The initial access reference signal may include a MIB. The type 0 CORESET may be quasi co-located with the initial access reference signal before RRC configuration or after a CFRA procedure that is not triggered by a PDCCH order. In some aspects, the initial access reference signal may include at least one of a PBCH DMRS or an SSB. In some aspects, the UE 120 may receive the indication of the indicated TCI state, wherein a TCI state associated with at least one of a UE-dedicated shared channel or a UE-dedicated control channel, prior to receiving the indication, is the initial TCI state. For example, after UE 120 is configured with a TCI state pool (with more than 1 TCI state) in RRC, but before a TCI from the pool is indicated by DCI as the indicated TCI, the UE-dedicated PDSCH and PDCCH may be associated with the TCI state corresponding to the SSB. If the RRC TCI state pool only includes 1 TCI state, then the RRC indicating the pool is a TCI indication.

In some aspects, the UE 120 and network node 110 may perform a RACH procedure that is not triggered by a PDCCH order, where the initial access reference signal may include an SSB associated with the RACH procedure. A TCI state associated with at least one of a UE-dedicated shared channel or a UE-dedicated control channel, after performing the RACH procedure, may be the initial TCI state. In some aspects, monitoring the at least one search space may include monitoring a type 0 search space for a SIB in a monitoring occasion that is based at least in part on a root SSB corresponding to the CSI-RS. The initial TCI state may be the indicated TCI state.

In some aspects, monitoring the at least one search space may include monitoring a type 0 search space for a SIB in a monitoring occasion that is based at least in part on a root SSB corresponding to a source reference signal associated with the indicated TCI state. The source reference signal may include at least one of a CSI-RS or a tracking reference signal.

In some aspects, the CORESET configuration may indicate at least one allowed search space type, of a set of two search space types, associated with the type 0 CORESET, where the set of two search space types comprises a UE-dedicated search space type and a non-UE-dedicated search space type. The at least one allowed search space type may include only the non-UE-dedicated search space type. The at least one allowed search space type may include the UE-dedicated search space type, where monitoring the at least one search space may include monitoring, in a monitoring occasion, only one search space type of the at least one allowed search space type. In some aspects, the at least one allowed search space type may include the UE-dedicated search space type, and monitoring the at least one search space may include monitoring, in a monitoring occasion, at least one of a UE-dedicated search space or a non-UE-dedicated search space. The at least one allowed search space type may include the UE-dedicated search space type, and a TCI state associated with a non-UE-dedicated search space of the at least one search space may also be associated with a UE-dedicated CORESET.

In some aspects, after the UE 120 is configured with more than one downlink or joint TCI states, a set of rules pertaining to QCL and uplink spatial filter assumptions may be used until the UE 120 receives a first instance of a downlink beam indication. In some aspects, for all PDSCH and/or PDCCH receptions in a component carrier (or in a set of configured component carriers with a common TCI state ID activation and update), as well as other signals and/or channels configured to share the same indicated TCI state as PDSCH and/or PDCCH reception, the UE 102 may determine that the corresponding DM-RS/CSI-RS antenna port is quasi co-located with the SS/PBCH block the UE 120 identified during the initial access procedure, or the SS/PBCH block or the CSI-RS resource the UE 120 identified during a RACH procedure initiated by a reconfiguration with synchronization procedure.

In some aspects, after the UE 120 is configured with a single downlink or joint indicated TCI state, a set of rules pertaining to QCL and uplink spatial filter assumptions may be used. In some aspects, for example, for all PDSCH and/or PDCCH receptions in a component carrier (or in a set of configured component carriers with a common TCI state ID activation and update), as well as other signals and/or channels configured to share the same indicated TCI state as the PDSCH and/or PDCCH reception, the UE 120 may determine that the corresponding DM-RS/CSI-RS antenna port is quasi co-located with the one or more downlink reference signals configured by the TCI state.

In some aspects, after the UE 120 is configured with more than one uplink or joint indicated TCI states, a set of rules pertaining to QCL and uplink spatial filter assumptions may be used until the UE 120 receives a first instance of an uplink beam indication. For example, for all physical uplink shared channel (PUSCH) transmissions and all of physical uplink control channel (PUCCH) resources in a component carrier (or in a set of configured component carriers with a common TCI state ID activation and update), as well as other signals and/or channels configured to share the same indicated TCI state as the PUSCH and all of the PUCCH resources, the UE 120 may transmit the uplink signal and/or channel using the same spatial domain transmission filter as for a PUSCH transmission scheduled by a random access response uplink grant as described in a wireless communication standard.

In some aspects, after the UE 120 is configured with a single uplink or joint indicated TCI state, a set of rules pertaining to QCL and uplink spatial filter assumptions may be used. For example, for all PUSCH transmissions and all of PUCCH resources in a component carrier (or in a set of configured component carriers with a common TCI state ID activation and update), as well as other signals and/or channels configured to share the same indicated TCI state as PUSCH and all of PUCCH resources, the UE 120 may transmit the uplink signal/channel using the same spatial domain transmission filter as determined with the spatial relation reference signal configured by the TCI state.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with CORESET type configurations.

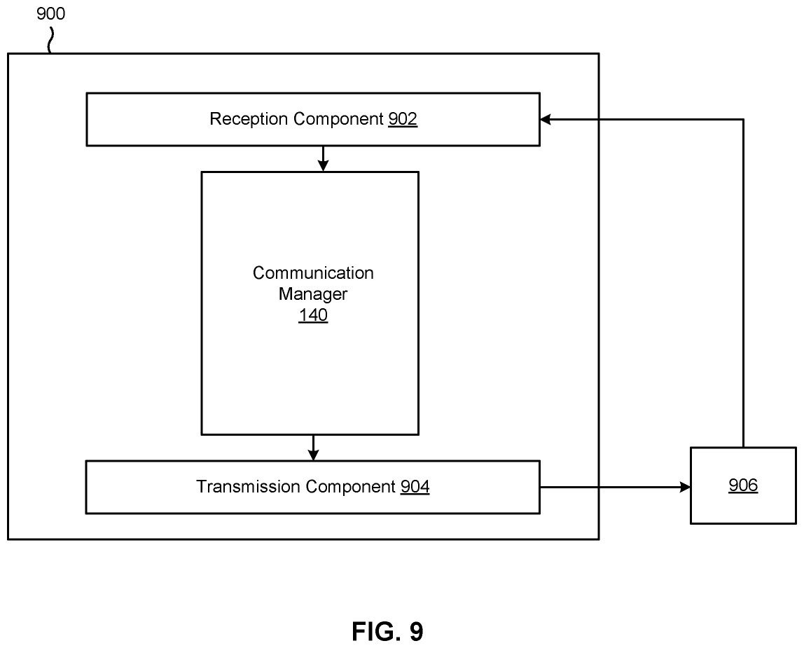

As shown in FIG. 5, in some aspects, process 500 may include receiving an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception (block 510). For example, the UE (e.g., using communication manager 140 and/or reception component 902, depicted in FIG. 9) may receive an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception, as described above. In some aspects, the set of possible CORESET types may include any subset of the CORESET types indicated above and/or any additional CORESET types.

As further shown in FIG. 5, in some aspects, process 500 may include monitoring at least one search space associated with at least one CORESET based at least in part on the CORESET configuration (block 520). For example, the UE (e.g., using communication manager 140 and/or reception component 902, depicted in FIG. 9) may monitor at least one search space associated with at least one CORESET based at least in part on the CORESET configuration, as described above.

Process 500 may include additional aspects, such as any single aspect or any combination of aspects described below and/or in connection with one or more other processes described elsewhere herein.

In some aspects, the CORESET configuration corresponds to one of an intercell beam management configuration or an intracell beam management configuration. In some aspects, process 500 includes receiving an indication of an additional CORESET configuration that corresponds to the other one of the intercell beam management configuration or the intracell beam management configuration. In some aspects, the one or more allowed CORESET types are the CORESET type 0, the CORESET type A, and the CORESET type B. In some aspects, the one or more allowed CORESET types include the CORESET type C, and the at least one search space is associated with a type C CORESET of the at least one CORESET, wherein the type C CORESET is a CORESET of CORESET type C. In some aspects, monitoring the at least one search space comprises monitoring, in a monitoring occasion of the type C CORESET, one or more search spaces of the at least one search space, wherein all of the one or more search spaces are UE-dedicated search spaces or all of the one or more search spaces are non-UE-dedicated search spaces. In some aspects, monitoring the at least one search space comprises monitoring, in a monitoring occasion of the type C CORESET, one or more search spaces of the at least one search space, wherein the one or more search spaces comprise at least one of a UE-dedicated search space or a non-UE-dedicated search space. In some aspects, process 500 includes receiving an indication of a TCI state corresponding to a type A CORESET of the at least one CORESET, wherein the TCI state corresponds to a non-UE-dedicated search space of the at least one search space, and wherein the type A CORESET is a CORESET of type A.

In some aspects, the one or more allowed CORESET types include the CORESET type C, wherein a type C CORESET of the at least one CORESET is associated with a UE-dedicated search space of the at least one search space, and wherein monitoring the at least one search space comprises monitoring the at least one search space based at least in part on a per-CORESET determination of a monitoring TCI state, wherein the type C CORESET is a CORESET of CORESET type C. In some aspects, process 500 includes receiving an indication of an indicated TCI state corresponding to a type A CORESET of the at least one CORESET, wherein the monitoring TCI state comprises the indicated TCI state, wherein the type A CORESET is a CORESET of CORESET type A. In some aspects, the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-CORESET determination of a monitoring TCI state, wherein the type C CORESET is a CORESET of CORESET type C.

In some aspects, process 500 includes receiving an indication of an indicated TCI state corresponding to a type A CORESET of the at least one CORESET, wherein the type A CORESET is a CORESET of CORESET type A, and receiving an indication of a TCI configuration, wherein the monitoring TCI state is based at least in part on the TCI configuration. In some aspects, the TCI state comprises the indicated TCI state based at least in part on the TCI configuration. In some aspects, receiving the indication of the TCI configuration comprises receiving a radio resource control message that includes the indication of the TCI configuration.

In some aspects, the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-monitoring occasion determination of a monitoring TCI state, wherein the type C CORESET is a CORESET of CORESET type C. In some aspects, includes receiving an indication of an indicated TCI state corresponding to a type A CORESET of the at least one CORESET, wherein the type A CORESET is a CORESET of CORESET type A, and receiving an indication of a TCI configuration, wherein the monitoring TCI state is based at least in part on the TCI configuration. In some aspects, the monitoring TCI state comprises the indicated TCI state based at least in part on the TCI configuration. In some aspects, receiving the indication of the TCI configuration comprises receiving a radio resource control message that includes the indication of the TCI configuration. In some aspects, the indicated TCI state is associated with the non-UE-dedicated search space, and monitoring the at least one search space comprises monitoring, in a plurality of monitoring occasions, the type C CORESET based at least in part on the indicated TCI state.

In some aspects, the monitoring TCI state does not include the indicated TCI state. In some aspects, monitoring the at least one search space comprises monitoring only search spaces of a UE-dedicated search space type in at least one monitoring occasion, wherein monitoring the at least one search space comprises monitoring the at least one search space based at least in part on the indicated TCI state. In some aspects, monitoring the at least one search space comprises monitoring only search spaces of a non-UE-dedicated search space type in at least one monitoring occasion, and process 500 includes receiving a MAC CE that indicates an updated TCI state, wherein monitoring the at least one search space comprises monitoring the at least one search space based at least in part on the updated TCI state. In some aspects, monitoring the at least one search space comprises monitoring, in at least one monitoring occasion, search spaces of a UE-dedicated search space type and search spaces of a non-UE-dedicated search space type. In some aspects, the monitoring TCI state is the indicated TCI state. In some aspects, process 500 includes receiving a MAC CE that indicates an updated TCI state, wherein the monitoring TCI state is the updated TCI state. In some aspects, the monitoring TCI state is based at least in part on at least one of a slot number or a search space configuration.

In some aspects, the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-search-space determination of a monitoring TCI state, wherein the type C CORESET is a CORESET of CORESET type C. In some aspects, process 500 includes receiving an indication of an indicated TCI state corresponding to a type A CORESET of the at least one CORESET, wherein the type A CORESET is a CORESET of CORESET type A, and receiving an indication of a TCI configuration, wherein the monitoring TCI state is based at least in part on the TCI configuration. In some aspects, the monitoring TCI state comprises the indicated TCI state based at least in part on the TCI configuration. In some aspects, receiving the indication of the TCI configuration comprises receiving a radio resource control message that includes the indication of the TCI configuration.

In some aspects, the indicated TCI state is associated with all non-UE-dedicated search spaces of the at least one search space, and monitoring the at least one search space comprises monitoring, in a plurality of monitoring occasions, the type C CORESET based at least in part on the indicated TCI state. In some aspects, the indicated TCI state is not associated with at least one non-UE-dedicated search space of the at least one search space. In some aspects, monitoring the at least one search space comprises monitoring, in at least one monitoring occasion, at least one of a UE-dedicated search space or a non-UE-dedicated search space associated with the indicated TCI state, wherein monitoring the at least one of the UE-dedicated search space or the non-UE-dedicated search space comprises monitoring the at least one of the UE-dedicated search space or the non-UE-dedicated search space based at least in part on the indicated TCI state. In some aspects, monitoring the at least one search space comprises monitoring, in at least one monitoring occasion, only at least one non-UE-dedicated search space that is not associated with the indicated TCI state, and process 500 includes receiving a MAC CE that indicates an updated TCI state, wherein monitoring the at least one non-UE-dedicated search space comprises monitoring the at least one non-UE-dedicated search space based at least in part on the updated TCI state.

In some aspects, monitoring the at least one search space comprises monitoring, in at least one monitoring occasion, at least one of a UE-dedicated search space, a non-UE-dedicated search space that is associated with the indicated TCI state, or at least one non-UE-dedicated search space that is not associated with the indicated TCI state. In some aspects, the monitoring TCI state is the indicated TCI state. In some aspects, process 500 includes receiving a MAC CE that indicates an updated TCI state, wherein the monitoring TCI state is the updated TCI state. In some aspects, the monitoring TCI state is based at least in part on at least one of a slot number or a search space configuration.

In some aspects, the at least one search space comprises at least one of a UE-dedicated search space or a non-UE-dedicated search space. In some aspects, the UE-dedicated search space comprises a USS, a type 3 CSS, or a type 2 CSS. In some aspects, the non-UE-dedicated search space comprises a type 0 CSS, a type OA CSS, a type 1 CSS, a type 2 CSS, a type 3 CSS, a search space 0, or a search space associated with a type 0 CORESET.

In some aspects, the at least one search space comprises a non-UE-dedicated search space based at least in part on a monitoring TCI state, and process 500 includes receiving a scheduling control channel communication, corresponding to the non-UE-dedicated search space, that schedules a shared channel communication corresponding to a non-UE-dedicated shared channel, and receiving the shared channel corresponding to the non-UE-dedicated shared channel based at least in part on the TCI state. In some aspects, the scheduling control channel communication includes a TCI field that indicates the TCI state. In some aspects, the scheduling control channel communication does not include a TCI field.

In some aspects, monitoring the at least one search space comprises monitoring the at least one search space based at least in part on a control channel repetition configuration. In some aspects, the control channel repetition configuration indicates a link between a type A CORESET of the at least one CORESET and a type C CORESET of the at least one CORESET, wherein the type A CORESET comprises a CORESET of CORESET type A, and wherein the type C CORESET comprises a CORESET of CORESET type C. In some aspects, a link between a type A CORESET of the at least one CORESET and an additional CORESET of the at least one CORESET comprises a link between the type A CORESET and an additional type A CORESET, wherein the type A CORESET comprises a CORESET of CORESET type A.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a UE, in accordance with the present disclosure. Example process 600 is an example where the UE (e.g., UE 120) performs operations associated with CORESET type configurations.

As shown in FIG. 6, in some aspects, process 600 may include receiving an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block (block 610). For example, the UE (e.g., using communication manager 140 and/or reception component 902, depicted in FIG. 9) may receive an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block, as described above.

As further shown in FIG. 6, in some aspects, process 600 may include monitoring at least one search space associated with the type 0 CORESET based at least in part on the initial TCI state (block 620). For example, the UE (e.g., using communication manager 140 and/or reception component 902, depicted in FIG. 9) may monitor at least one search space associated with the type 0 CORESET based at least in part on the initial TCI state, as described above.

Process 600 may include additional aspects, such as any single aspect or any combination of aspects described below and/or in connection with one or more other processes described elsewhere herein.

In some aspects, the type 0 CORESET is quasi co-located with the initial access reference signal before RRC configuration or after a CFRA procedure that is not triggered by a PDCCH order. In some aspects, the initial access reference signal comprises at least one of a PBCH DMRS or an SSB. In some aspects, process 600 includes receiving an indication of an indicated TCI state, wherein a TCI state associated with at least one of a UE-dedicated shared channel or a UE-dedicated control channel, prior to receiving the indication, is the initial TCI state. In some aspects, process 600 includes performing a RACH procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state.

In some aspects, process 600 includes receiving a DCI transmission that indicates an indicated TCI state, and receiving an RRC configuration that indicates the initial TCI state. In some aspects, the initial TCI state is different than the indicated TCI state. In some aspects, process 600 includes receiving a MAC CE that indicates an updated TCI state associated with the type 0 CORESET. In some aspects, the MAC CE indicates at least one of a CSI-RS or an SSB. In some aspects, monitoring the at least one search space comprises monitoring a type 0 search space for a system information block in a monitoring occasion that is based at least in part on a root SSB corresponding to the CSI-RS.

In some aspects, the initial TCI state is the indicated TCI state. In some aspects, monitoring the at least one search space comprises monitoring a type 0 search space for a system information block in a monitoring occasion that is based at least in part on a root SSB corresponding to a source reference signal associated with the indicated TCI state. In some aspects, the source reference signal comprises at least one of a channel state information reference signal or a tracking reference signal.

In some aspects, the CORESET configuration indicates at least one allowed search space type, of a set of two search space types, associated with the type 0 CORESET, wherein the set of two search space types comprises a UE-dedicated search space type and a non-UE-dedicated search space type. In some aspects, the at least one allowed search space type includes only the non-UE-dedicated search space type. In some aspects, the at least one allowed search space type includes the UE-dedicated search space type, wherein monitoring the at least one search space comprises monitoring, in a monitoring occasion, only one search space type of the at least one allowed search space type. In some aspects, the at least one allowed search space type includes the UE-dedicated search space type, wherein monitoring the at least one search space comprises monitoring, in a monitoring occasion, at least one of a UE-dedicated search space or a non-UE-dedicated search space. In some aspects, the at least one allowed search space type includes the UE-dedicated search space type, wherein a TCI state associated with a non-UE-dedicated search space of the at least one search space is also associated with a UE-dedicated CORESET.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with CORESET type configurations.

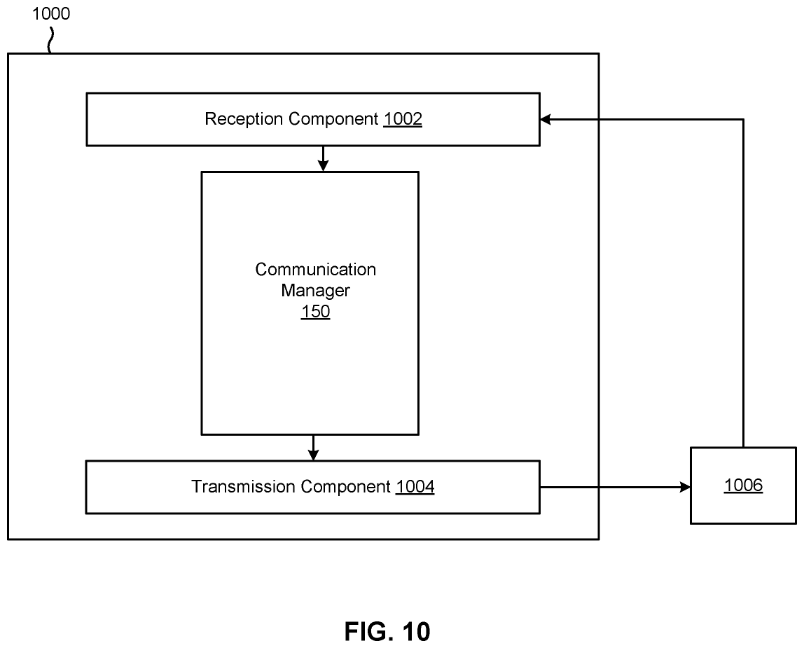

As shown in FIG. 7, in some aspects, process 700 may include transmitting an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception (block 710). For example, the network node (e.g., using communication manager 150 and/or transmission component 1002, depicted in FIG. 10) may transmit an indication of a CORESET configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception, as described above. In some aspects, the set of possible CORESET types may include any subset of the CORESET types indicated above and/or any additional CORESET types.

As further shown in FIG. 7, in some aspects, process 700 may include transmitting at least one control channel communication in at least one search space associated with at least one CORESET based at least in part on the CORESET configuration (block 720). For example, the network node (e.g., using communication manager 150 and/or transmission component 1004, depicted in FIG. 10) may transmit at least one control channel communication in at least one search space associated with at least one CORESET based at least in part on the CORESET configuration, as described above.

Process 700 may include additional aspects, such as any single aspect or any combination of aspects described below and/or in connection with one or more other processes described elsewhere herein.

In some aspects, the CORESET configuration corresponds to one of an intercell beam management configuration or an intracell beam management configuration. In some aspects, process 700 includes transmitting an indication of an additional CORESET configuration that corresponds to the other one of the intercell beam management configuration or the intracell beam management configuration. In some aspects, the one or more allowed CORESET types are the CORESET type 0, the CORESET type A, and the CORESET type B. In some aspects, the one or more allowed CORESET types include the CORESET type C, and the at least one search space is associated with a type C CORESET of the at least one CORESET, wherein the type C CORESET is a CORESET of CORESET type C. In some aspects, the at least one search space comprise once or more search spaces corresponding to a monitoring occasion of the type C CORESET, wherein all of the one or more search spaces are UE-dedicated search spaces or all of the one or more search spaces are non-UE-dedicated search spaces. In some aspects, the at least one search space comprise one or more search spaces corresponding to a monitoring occasion of the type C CORESET, wherein the one or more search spaces comprise at least one of a UE-dedicated search space or a non-UE-dedicated search space.

In some aspects, process 700 includes transmitting an indication of a TCI state corresponding to a type A CORESET of the at least one CORESET, wherein the TCI state corresponds to a non-UE-dedicated search space of the at least one search space, and wherein the type A CORESET is a CORESET of type A. In some aspects, the one or more allowed CORESET types include the CORESET type C, wherein a type C CORESET of the at least one CORESET is associated with a UE-dedicated search space of the at least one search space, and wherein a monitoring TCI state associated with the at least one search space is based at least in part on a per-CORESET determination, wherein the type C CORESET is a CORESET of CORESET type C.

In some aspects, process 700 includes transmitting an indication of an indicated TCI state corresponding to a type A CORESET of the at least one CORESET, wherein the monitoring TCI state comprises the indicated TCI state, wherein the type A CORESET is a CORESET of CORESET type A. In some aspects, the one or more allowed CORESET types include the CORESET type C, wherein a type C CORESET of the at least one CORESET is associated with a non-UE-dedicated search space of the at least one search space, and wherein a monitoring TCI state associated with the at least one search space is based at least in part on a per-CORESET determination, wherein the type C CORESET is a CORESET of CORESET type C. In some aspects, process 700 includes transmitting an indication of an indicated TCI state corresponding to a type A CORESET of the at least one CORESET, wherein the type A CORESET is a CORESET of CORESET type A, and transmitting an indication of a TCI configuration, wherein the monitoring TCI state is based at least in part on the TCI configuration. In some aspects, the TCI state comprises the indicated TCI state based at least in part on the TCI configuration. In some aspects, transmitting the indication of the TCI configuration comprises transmitting a radio resource control message that includes the indication of the TCI configuration.

In some aspects, the one or more allowed CORESET types include the CORESET type C, wherein a type C CORESET of the at least one CORESET is associated with a non-UE-dedicated search space of the at least one search space, and wherein a monitoring TCI state associated with the at least one search space is based at least in part on a per-monitoring occasion determination, wherein the type C CORESET is a CORESET of CORESET type C. In some aspects, process 700 includes transmitting an indication of an indicated TCI state corresponding to a type A CORESET of the at least one CORESET, wherein the type A CORESET is a CORESET of CORESET type A, and transmitting an indication of a TCI configuration, wherein the monitoring TCI state is based at least in part on the TCI configuration. In some aspects, the monitoring TCI state comprises the indicated TCI state based at least in part on the TCI configuration. In some aspects, transmitting the indication of the TCI configuration comprises transmitting a radio resource control message that includes the indication of the TCI configuration. In some aspects, the indicated TCI state is associated with the non-UE-dedicated search space, and a plurality of monitoring occasions corresponding to the at least one search space are associated with the type C CORESET based at least in part on the indicated TCI state.

In some aspects, the monitoring TCI state does not include the indicated TCI state. In some aspects, at least one monitoring occasion corresponds to only search spaces of a UE-dedicated search space type and is associated with the indicated TCI state. In some aspects, at least one monitoring occasion corresponds to only search spaces of a non-UE-dedicated search space type, and process 700 includes transmitting a MAC CE that indicates an updated TCI state associated with the at least one monitoring occasion. In some aspects, at least one monitoring occasion corresponds to search spaces of a UE-dedicated search space type and search spaces of a non-UE-dedicated search space type.

In some aspects, the monitoring TCI state is the indicated TCI state. In some aspects, process 700 includes transmitting a MAC CE that indicates an updated TCI state, wherein the monitoring TCI state is the updated TCI state. In some aspects, the monitoring TCI state is based at least in part on at least one of a slot number or a search space configuration.

In some aspects, the one or more allowed CORESET types include the CORESET type C, wherein a type C CORESET of the at least one CORESET is associated with a non-UE-dedicated search space of the at least one search space, and wherein a monitoring TCI state associated with the at least one search space is based at least in part on a per-search-space determination, wherein the type C CORESET is a CORESET of CORESET type C. In some aspects, process 700 includes transmitting an indication of an indicated TCI state corresponding to a type A CORESET of the at least one CORESET, wherein the type A CORESET is a CORESET of CORESET type A, and transmitting an indication of a TCI configuration, wherein the monitoring TCI state is based at least in part on the TCI configuration. In some aspects, the monitoring TCI state comprises the indicated TCI state based at least in part on the TCI configuration. In some aspects, transmitting the indication of the TCI configuration comprises transmitting a radio resource control message that includes the indication of the TCI configuration.

In some aspects, the indicated TCI state is associated with all non-UE-dedicated search spaces of the at least one search space, and a plurality of monitoring occasions corresponding to the type C CORESET are associated with the indicated TCI state. In some aspects, the indicated TCI state is not associated with at least one non-UE-dedicated search space of the at least one search space. In some aspects, the indicated TCI state is associated with at least one monitoring occasion corresponding to at least one of a UE-dedicated search space or a non-UE-dedicated search space associated with the indicated TCI state. In some aspects, process 700 includes transmitting a MAC CE that indicates an updated TCI state associated with at least one monitoring occasion corresponding to at least one non-UE-dedicated search space that is not associated with the indicated TCI state.

In some aspects, at least one monitoring occasion corresponds to at least one of a UE-dedicated search space, a non-UE-dedicated search space that is associated with the indicated TCI state, or at least one non-UE-dedicated search space that is not associated with the indicated TCI state. In some aspects, the monitoring TCI state is the indicated TCI state. In some aspects, process 700 includes transmitting a MAC CE that indicates an updated TCI state, wherein the monitoring TCI state is the updated TCI state. In some aspects, the monitoring TCI state is based at least in part on at least one of a slot number or a search space configuration.

In some aspects, the at least one search space comprises at least one of a UE-dedicated search space or a non-UE-dedicated search space. In some aspects, the UE-dedicated search space comprises a USS, a type 3 CSS, or a type 2 CSS. In some aspects, the non-UE-dedicated search space comprises a type 0 CSS, a type OA CSS, a type 1 CSS, a type 2 CSS, a type 3 CSS, a search space 0, or a search space associated with a type 0 CORESET.

In some aspects, the at least one search space comprises a non-UE-dedicated search space based at least in part on a monitoring TCI state, and process 700 includes transmitting a scheduling control channel communication, corresponding to the non-UE-dedicated search space, that schedules a shared channel communication corresponding to a non-UE-dedicated shared channel, and transmitting the shared channel corresponding to the non-UE-dedicated shared channel based at least in part on the TCI state. In some aspects, the scheduling control channel communication includes a TCI field that indicates the TCI state. In some aspects, the scheduling control channel communication does not include a TCI field.

In some aspects, the at least one search space corresponds to a control channel repetition configuration In some aspects, the control channel repetition configuration indicates a link between a type A CORESET of the at least one CORESET and a type C CORESET of the at least one CORESET, wherein the type A CORESET comprises a CORESET of CORESET type A, and wherein the type C CORESET comprises a CORESET of CORESET type C. In some aspects, a link between a type A CORESET of the at least one CORESET and an additional CORESET of the at least one CORESET comprises a link between the type A CORESET and an additional type A CORESET, wherein the type A CORESET comprises a CORESET of CORESET type A.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with CORESET type configurations.

As shown in FIG. 8, in some aspects, process 800 may include transmitting an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block (block 810). For example, the network node (e.g., using communication manager 150 and/or transmission component 1004, depicted in FIG. 10) may transmit an indication of CORESET configuration of a type 0 CORESET associated with initial network access, wherein the type 0 CORESET is quasi co-located with an initial access reference signal based at least in part on an initial TCI state, wherein the initial access reference signal comprises a master information block, as described above.

As further shown in FIG. 8, in some aspects, process 800 may include transmitting at least one control channel communication in at least one search space associated with the type 0 CORESET based at least in part on the initial TCI state (block 820). For example, the network node (e.g., using communication manager 150 and/or transmission component 1004, depicted in FIG. 10) may transmit at least one control channel communication in at least one search space associated with the type 0 CORESET based at least in part on the initial TCI state, as described above.

Process 800 may include additional aspects, such as any single aspect or any combination of aspects described below and/or in connection with one or more other processes described elsewhere herein.

In some aspects, the type 0 CORESET is quasi co-located with the initial access reference signal before radio resource control configuration or after a contention free random access channel procedure that is not triggered by a physical downlink control channel order. In some aspects, the initial access reference signal comprises at least one of a physical broadcast channel demodulation reference signal or a synchronization signal block. In some aspects, process 800 includes transmitting an indication of an indicated TCI state, wherein a TCI state associated with at least one of a UE-dedicated shared channel or a UE-dedicated control channel, prior to receiving the indication, is the initial TCI state. In some aspects, process 800 includes performing a RACH procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state.

In some aspects, process 800 includes transmitting a downlink control information transmission that indicates an indicated TCI state, and transmitting a radio resource control configuration that indicates the initial TCI state. In some aspects, the initial TCI state is different than the indicated TCI state.

In some aspects, process 800 includes transmitting a MAC CE that indicates an updated TCI state associated with the type 0 CORESET. In some aspects, the MAC CE indicates at least one of a CSI-RS or an SSB. In some aspects, process 800 includes transmitting a system information block in a type 0 search space of the at least one search space, wherein a monitoring occasion corresponding to the type 0 search space is based at least in part on a root SSB corresponding to the CSI-RS.

In some aspects, the initial TCI state is the indicated TCI state. In some aspects, process 800 includes transmitting a system information block in a type 0 search space, wherein a monitoring occasion corresponding to the type 0 search space is based at least in part on a root synchronization signal block corresponding to a source reference signal associated with the indicated TCI state. In some aspects, the source reference signal comprises at least one of a channel state information reference signal or a tracking reference signal.

In some aspects, the CORESET configuration indicates at least one allowed search space type, of a set of two search space types, associated with the type 0 CORESET, wherein the set of two search space types comprises a UE-dedicated search space type and a non-UE-dedicated search space type. In some aspects, the at least one allowed search space type includes only the non-UE-dedicated search space type. In some aspects, the at least one allowed search space type includes the UE-dedicated search space type, and a monitoring occasion corresponds to only one search space type of the at least one allowed search space type. In some aspects, the at least one allowed search space type includes the UE-dedicated search space type, and a monitoring occasion corresponds to at least one of a UE-dedicated search space or a non-UE-dedicated search space. In some aspects, the at least one allowed search space type includes the UE-dedicated search space type, wherein a TCI state associated with a non-UE-dedicated search space of the at least one search space is also associated with a UE-dedicated CORESET.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a network node, or another wireless communication device) using the reception component 902 and the transmission component 904. As further shown, the apparatus 900 may include the communication manager 140.

In some aspects, the apparatus 900 may be configured to perform one or more operations described herein in connection with FIG. 4. Additionally, or alternatively, the apparatus 900 may be configured to perform one or more processes described herein, such as process 500 of FIG. 5, process 600 of FIG. 6, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive an indication of a CORESET configuration that indicates one or more allowed CORESET types, of a set of possible CORESET types, associated with control channel reception corresponding to a component carrier, wherein the set of possible CORESET types comprises a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception. In some aspects, the set of possible CORESET types may include any subset of the CORESET types indicated above and/or any additional CORESET types.

The communication manager 140 and/or the reception component 902 may monitor at least one search space associated with at least one CORESET based at least in part on the CORESET configuration. In some aspects, the communication manager 140 may include one or more antennas, a modem, a demodulator, a MIMO detector, a receive processor, a controller/processor, a memory, or a combination thereof, of the UE described in connection with FIG. 2. In some aspects, the communication manager 140 may include the reception component 902 and/or the transmission component 904.

The reception component 902 may receive an indication of a TCI state corresponding to a type A CORESET of the at least one CORESET, wherein the TCI state corresponds to a non-UE-dedicated search space of the at least one search space, and wherein the type A CORESET is a CORESET of type A. The reception component 902 may receive an indication of an additional CORESET configuration that corresponds to the other one of the intercell beam management configuration or the intracell beam management configuration. The reception component 902 may receive an indication of an indicated TCI state corresponding to a type A CORESET of the at least one CORESET, wherein the monitoring TCI state comprises the indicated TCI state, wherein the type A CORESET is a CORESET of CORESET type A.

The reception component 902 may receive an indication of an indicated TCI state corresponding to a type A CORESET of the at least one CORESET, wherein the type A CORESET is a CORESET of CORESET type A. The reception component 902 may receive an indication of a TCI configuration, wherein the monitoring TCI state is based at least in part on the TCI configuration.

The reception component 902 may receive an indication of an indicated TCI state corresponding to a type A CORESET of the at least one CORESET, wherein the type A CORESET is a CORESET of CORESET type A. The reception component 902 may receive an indication of a TCI configuration, wherein the monitoring TCI state is based at least in part on the TCI configuration. The reception component 902 may receive a MAC CE that indicates an updated TCI state, wherein the monitoring TCI state is the updated TCI state. The reception component 902 may receive an indication of an indicated TCI state corresponding to a type A CORESET of the at least one CORESET, wherein the type A CORESET is a CORESET of CORESET type A.

The reception component 902 may receive an indication of a TCI configuration, wherein the monitoring TCI state is based at least in part on the TCI configuration. The reception component 902 may receive a MAC CE that indicates an updated TCI state, wherein the monitoring TCI state is the updated TCI state.

The reception component 902 may receive an indication of a CORESET configuration of a type 0 CORESET associated with initial network access, wherein the type 0 CORESET is quasi co-located with an initial access reference signal based at least in part on an initial TCI state, wherein the initial access reference signal comprises a master information block. The communication manager 140 and/or the reception component 902 may monitor at least one search space associated with the type 0 CORESET based at least in part on the initial TCI state.

The reception component 902 may receive an indication of an indicated TCI state, wherein a TCI state associated with at least one of a UE-dedicated shared channel or a UE-dedicated control channel, prior to receiving the indication, is the initial TCI state. The communication manager 140, the reception component 902, and/or the transmission component 904, may perform a RACH procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state.

The reception component 902 may receive a DCI transmission that indicates an indicated TCI state. The reception component 902 may an RRC configuration that indicates the initial TCI state. The reception component 902 may receive a MAC CE that indicates an updated TCI state associated with the type 0 CORESET.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or another wireless communication device) using the reception component 1002 and the transmission component 1004. As further shown, the apparatus 1000 may include the communication manager 150.

In some aspects, the apparatus 1000 may be configured to perform one or more operations described herein in connection with FIG. 5. Additionally, or alternatively, the apparatus 1000 may be configured to perform one or more processes described herein, such as process 700 of FIG. 7, process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit an indication of a CORESET configuration that indicates one or more allowed CORESET types, of a set of possible CORESET types, associated with control channel reception corresponding to a component carrier, wherein the set of possible CORESET types comprises a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception. In some aspects, the set of possible CORESET types may include any subset of the CORESET types indicated above and/or any additional CORESET types. The transmission component 1004 may transmit at least one control channel communication in at least one search space associated with at least one CORESET based at least in part on the CORESET configuration.

The transmission component 1004 may transmit an indication of a TCI state corresponding to a type A CORESET of the at least one CORESET, wherein the TCI state corresponds to a non-UE-dedicated search space of the at least one search space, and wherein the type A CORESET is a CORESET of type A. The transmission component 1004 may transmit an indication of an additional CORESET configuration that corresponds to the other one of the intercell beam management configuration or the intracell beam management configuration.

The transmission component 1004 may transmit an indication of an indicated TCI state corresponding to a type A CORESET of the at least one CORESET, wherein the monitoring TCI state comprises the indicated TCI state, wherein the type A CORESET is a CORESET of CORESET type A. The transmission component 1004 may transmit an indication of an indicated TCI state corresponding to a type A CORESET of the at least one CORESET, wherein the type A CORESET is a CORESET of CORESET type A. The transmission component 1004 may transmit an indication of a TCI configuration, wherein the monitoring TCI state is based at least in part on the TCI configuration.

The transmission component 1004 may transmit an indication of an indicated TCI state corresponding to a type A CORESET of the at least one CORESET, wherein the type A CORESET is a CORESET of CORESET type A. The transmission component 1004 may transmit an indication of a TCI configuration, wherein the monitoring TCI state is based at least in part on the TCI configuration.

The transmission component 1004 may transmit a MAC CE that indicates an updated TCI state, wherein the monitoring TCI state is the updated TCI state. The transmission component 1004 may transmit an indication of an indicated TCI state corresponding to a type A CORESET of the at least one CORESET, wherein the type A CORESET is a CORESET of CORESET type A. The transmission component 1004 may transmit an indication of a TCI configuration, wherein the monitoring TCI state is based at least in part on the TCI configuration.

The transmission component 1004 may transmit a MAC CE that indicates an updated TCI state associated with at least one monitoring occasion corresponding to at least one non-UE-dedicated search space that is not associated with the indicated TCI state. The transmission component 1004 may transmit a MAC CE that indicates an updated TCI state, wherein the monitoring TCI state is the updated TCI state.

The transmission component 1004 may transmit an indication of CORESET configuration of a type 0 CORESET associated with initial network access, wherein the type 0 CORESET is quasi co-located with an initial access reference signal based at least in part on an initial TCI state, wherein the initial access reference signal comprises a master information block. The transmission component 1004 may transmit at least one control channel communication in at least one search space associated with the type 0 CORESET based at least in part on the initial TCI state. The transmission component 1004 may transmit an indication of an indicated TCI state, wherein a TCI state associated with at least one of a UE-dedicated shared channel or a UE-dedicated control channel, prior to receiving the indication, is the initial TCI state.

The communication manager 150, the reception component 1002, and/or the transmission component 1004 may perform a RACH procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state. In some aspects, the communication manager 150 may include one or more antennas, a modem, a demodulator, a MIMO detector, a receive processor, a controller/processor, a memory, or a combination thereof, of the network node described in connection with FIG. 2. In some aspects, the communication manager 150 may include the reception component 1002 and/or the transmission component 1004.

The transmission component 1004 may transmit a downlink control information transmission that indicates an indicated TCI state. The transmission component 1004 may transmit a radio resource control configuration that indicates the initial TCI state. The transmission component 1004 may transmit a MAC CE that indicates an updated TCI state associated with the type 0 CORESET.

The transmission component 1004 may transmit a system information block in a type 0 search space of the at least one search space, wherein a monitoring occasion corresponding to the type 0 search space is based at least in part on a root SSB corresponding to the CSI-RS. The transmission component 1004 may transmit a system information block in a type 0 search space, wherein a monitoring occasion corresponding to the type 0 search space is based at least in part on a root synchronization signal block corresponding to a source reference signal associated with the indicated TCI state.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram illustrating an example disaggregated base station architecture 1100, in accordance with the present disclosure. The disaggregated base station architecture 1100 may include a CU 1110 that can communicate directly with a core network 1120 via a backhaul link, or indirectly with the core network 1120 through one or more disaggregated control units (such as a Near-RT RIC 1125 via an E2 link, or a Non-RT RIC 1115 associated with a Service Management and Orchestration (SMO) Framework 1105, or both). A CU 1110 may communicate with one or more DUs 1130 via respective midhaul links, such as through F1 interfaces. Each of the DUs 1130 may communicate with one or more RUs 1140 via respective fronthaul links. Each of the RUs 1140 may communicate with one or more UEs 120 via respective radio frequency (RF) access links. In some implementations, a UE 120 may be simultaneously served by multiple RUs 1140.

Each of the units, including the CUs 1110, the DUs 1130, the RUs 1140, as well as the Near-RT RICs 1125, the Non-RT RICs 1115, and the SMO Framework 1105, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 1110 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 1110. The CU 1110 may be configured to handle user plane functionality (for example, Central Unit-User Plane (CU-UP) functionality), control plane functionality (for example, Central Unit-Control Plane (CU-CP) functionality), or a combination thereof. In some implementations, the CU 1110 can be logically split into one or more CU-UP units and one or more CU-CP units. A CU-UP unit can communicate bidirectionally with a CU-CP unit via an interface, such as the E1 interface when implemented in an O-RAN configuration. The CU 1110 can be implemented to communicate with a DU 1130, as necessary, for network control and signaling.

Each DU 1130 may correspond to a logical unit that includes one or more base station functions to control the operation of one or more RUs 1140. In some aspects, the DU 1130 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 1130 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 1130, or with the control functions hosted by the CU 1110.

Each RU 1140 may implement lower-layer functionality. In some deployments, an RU 1140, controlled by a DU 1130, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 1140 can be operated to handle over the air (OTA) communication with one or more UEs 120. In some implementations, real-time and non-real-time aspects of control and user plane communication with the RU(s) 1140 can be controlled by the corresponding DU 1130. In some scenarios, this configuration can enable each DU 1130 and the CU 1110 to be implemented in a cloud-based RAN architecture, such as a vRAN architecture.

The SMO Framework 1105 may be configured to support RAN deployment and provisioning of non-virtualized and virtualized network elements. For non-virtualized network elements, the SMO Framework 1105 may be configured to support the deployment of dedicated physical resources for RAN coverage requirements, which may be managed via an operations and maintenance interface (such as an O1 interface). For virtualized network elements, the SMO Framework 1105 may be configured to interact with a cloud computing platform (such as an open cloud (O-Cloud) platform 1190) to perform network element life cycle management (such as to instantiate virtualized network elements) via a cloud computing platform interface (such as an O2 interface). Such virtualized network elements can include, but are not limited to, CUs 1110, DUs 1130, RUs 1140, non-RT RICs 1115, and Near-RT RICs 1125. In some implementations, the SMO Framework 1105 can communicate with a hardware aspect of a 4G RAN, such as an open eNB (O-eNB) 1111, via an O1 interface. Additionally, in some implementations, the SMO Framework 1105 can communicate directly with each of one or more RUs 1140 via a respective O1 interface. The SMO Framework 1105 also may include a Non-RT RIC 1115 configured to support functionality of the SMO Framework 1105.

The Non-RT RIC 1115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1125. The Non-RT RIC 1115 may be coupled to or communicate with (such as via an A1 interface) the Near-RT RIC 1125. The Near-RT RIC 1125 may be configured to include a logical function that enables near-real-time control and optimization of RAN elements and resources via data collection and actions over an interface (such as via an E2 interface) connecting one or more CUs 1110, one or more DUs 1130, or both, as well as an O-eNB, with the Near-RT RIC 1125.

In some implementations, to generate AI/ML models to be deployed in the Near-RT RIC 1125, the Non-RT RIC 1115 may receive parameters or external enrichment information from external servers. Such information may be utilized by the Near-RT RIC 1125 and may be received at the SMO Framework 1105 or the Non-RT RIC 1115 from non-network data sources or from network functions. In some examples, the Non-RT RIC 1115 or the Near-RT RIC 1125 may be configured to tune RAN behavior or performance. For example, the Non-RT RIC 1115 may monitor long-term trends and patterns for performance and employ AI/ML models to perform corrective actions through the SMO Framework 1105 (such as reconfiguration via an O1 interface) or via creation of RAN management policies (such as A1 interface policies).

The following provides an overview of some Aspects of the present disclosure:

Aspect 1: A method of wireless communication performed by a user equipment (UE), comprising: receiving an indication of a control resource set (CORESET) configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception; and monitoring at least one search space associated with at least one CORESET based at least in part on the CORESET configuration.

Aspect 2: The method of Aspect 1, wherein the one or more allowed CORESET types are the CORESET type 0, the CORESET type A, and the CORESET type B.

Aspect 3: The method of Aspect 1, wherein the one or more allowed CORESET types include the CORESET type C, and wherein the at least one search space is associated with a type C CORESET of the at least one CORESET, wherein the type C CORESET is a CORESET of CORESET type C.

Aspect 4: The method of Aspect 3, wherein monitoring the at least one search space comprises monitoring, in a monitoring occasion of the type C CORESET, one or more search spaces of the at least one search space, wherein all of the one or more search spaces are UE-dedicated search spaces or all of the one or more search spaces are non-UE-dedicated search spaces.

Aspect 5: The method of Aspect 3, wherein monitoring the at least one search space comprises monitoring, in a monitoring occasion of the type C CORESET, one or more search spaces of the at least one search space, wherein the one or more search spaces comprise at least one of a UE-dedicated search space or a non-UE-dedicated search space.

Aspect 6: The method of any of Aspects 3-5, further comprising receiving an indication of a transmission configuration indicator (TCI) state corresponding to a type A CORESET of the at least one CORESET, wherein the TCI state corresponds to a non-UE-dedicated search space of the at least one search space, and wherein the type A CORESET is a CORESET of type A.

Aspect 7: The method of any of Aspects 1-6, wherein the CORESET configuration corresponds to one of an intercell beam management configuration or an intracell beam management configuration.

Aspect 8: The method of Aspect 7, further comprising receiving an indication of an additional CORESET configuration that corresponds to the other one of the intercell beam management configuration or the intracell beam management configuration.

Aspect 9: The method of Aspect 1, wherein the one or more allowed CORESET types include the CORESET type C, wherein a type C CORESET of the at least one CORESET is associated with a UE-dedicated search space of the at least one search space, and wherein monitoring the at least one search space comprises monitoring the at least one search space based at least in part on a per-CORESET determination of a monitoring transmission configuration indicator (TCI) state, wherein the type C CORESET is a CORESET of CORESET type C.

Aspect 10: The method of Aspect 9, further comprising receiving an indication of an indicated TCI state corresponding to a type A CORESET of the at least one CORESET, wherein the monitoring TCI state comprises the indicated TCI state, wherein the type A CORESET is a CORESET of CORESET type A.

Aspect 11: The method of Aspect 1, wherein the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-CORESET determination of a monitoring transmission configuration indicator (TCI) state, wherein the type C CORESET is a CORESET of CORESET type C.

Aspect 12: The method of Aspect 11, further comprising: receiving an indication of an indicated TCI state corresponding to a type A CORESET of the at least one CORESET, wherein the type A CORESET is a CORESET of CORESET type A; and receiving an indication of a TCI configuration, wherein the monitoring TCI state is based at least in part on the TCI configuration.

Aspect 13: The method of Aspect 12, wherein the TCI state comprises the indicated TCI state based at least in part on the TCI configuration.

Aspect 14: The method of either of Aspects 12 or 13, wherein receiving the indication of the TCI configuration comprises receiving a radio resource control message that includes the indication of the TCI configuration.

Aspect 15: The method of Aspect 1, wherein the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-monitoring occasion determination of a monitoring transmission configuration indicator (TCI) state, wherein the type C CORESET is a CORESET of CORESET type C.

Aspect 16: The method of Aspect 15, further comprising: receiving an indication of an indicated TCI state corresponding to a type A CORESET of the at least one CORESET, wherein the type A CORESET is a CORESET of CORESET type A; and receiving an indication of a TCI configuration, wherein the monitoring TCI state is based at least in part on the TCI configuration.

Aspect 17: The method of Aspect 16, wherein the monitoring TCI state comprises the indicated TCI state based at least in part on the TCI configuration.

Aspect 18: The method of either of Aspects 16 or 17, wherein receiving the indication of the TCI configuration comprises receiving a radio resource control message that includes the indication of the TCI configuration.

Aspect 19: The method of any of Aspects 16-18, wherein the indicated TCI state is associated with the non-UE-dedicated search space, and wherein monitoring the at least one search space comprises monitoring, in a plurality of monitoring occasions, the type C CORESET based at least in part on the indicated TCI state.

Aspect 20: The method of any of Aspects 16-18, wherein the monitoring TCI state does not include the indicated TCI state.

Aspect 21: The method of Aspect 20, wherein monitoring the at least one search space comprises monitoring only search spaces of a UE-dedicated search space type in at least one monitoring occasion, wherein monitoring the at least one search space comprises monitoring the at least one search space based at least in part on the indicated TCI state.

Aspect 22: The method of either of Aspects 20 or 21, wherein monitoring the at least one search space comprises monitoring only search spaces of a non-UE-dedicated search space type in at least one monitoring occasion, the method further comprising receiving a medium access control control element that indicates an updated TCI state, wherein monitoring the at least one search space comprises monitoring the at least one search space based at least in part on the updated TCI state.

Aspect 23: The method of any of Aspects 20-21, wherein monitoring the at least one search space comprises monitoring, in at least one monitoring occasion, search spaces of a UE-dedicated search space type and search spaces of a non-UE-dedicated search space type.

Aspect 24: The method of Aspect 23, wherein the monitoring TCI state is the indicated TCI state.

Aspect 25: The method of Aspect 23, further comprising receiving a medium access control control element that indicates an updated TCI state, wherein the monitoring TCI state is the updated TCI state.

Aspect 26: The method of any of Aspects 20-25, wherein the monitoring TCI state is based at least in part on at least one of a slot number or a search space configuration.

Aspect 27: The method of Aspect 1, wherein the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-search-space determination of a monitoring transmission configuration indicator (TCI) state, wherein the type C CORESET is a CORESET of CORESET type C.

Aspect 28: The method of Aspect 27, further comprising: receiving an indication of an indicated TCI state corresponding to a type A CORESET of the at least one CORESET, wherein the type A CORESET is a CORESET of CORESET type A; and receiving an indication of a TCI configuration, wherein the monitoring TCI state is based at least in part on the TCI configuration.

Aspect 29: The method of Aspect 28, wherein the monitoring TCI state comprises the indicated TCI state based at least in part on the TCI configuration.

Aspect 30: The method of either of Aspects 28 or 29, wherein receiving the indication of the TCI configuration comprises receiving a radio resource control message that includes the indication of the TCI configuration.

Aspect 31: The method of any of Aspects 28-30, wherein the indicated TCI state is associated with all non-UE-dedicated search spaces of the at least one search space, and wherein monitoring the at least one search space comprises monitoring, in a plurality of monitoring occasions, the type C CORESET based at least in part on the indicated TCI state.

Aspect 32: The method of any of Aspects 28-30, wherein the indicated TCI state is not associated with at least one non-UE-dedicated search space of the at least one search space.

Aspect 33: The method of Aspect 32, wherein monitoring the at least one search space comprises monitoring, in at least one monitoring occasion, at least one of a UE-dedicated search space or a non-UE-dedicated search space associated with the indicated TCI state, wherein monitoring the at least one of the UE-dedicated search space or the non-UE-dedicated search space comprises monitoring the at least one of the UE-dedicated search space or the non-UE-dedicated search space based at least in part on the indicated TCI state.

Aspect 34: The method of either of Aspects 32 or 33, wherein monitoring the at least one search space comprises monitoring, in at least one monitoring occasion, only at least one non-UE-dedicated search space that is not associated with the indicated TCI state, the method further comprising receiving a medium access control control element that indicates an updated TCI state, wherein monitoring the at least one non-UE-dedicated search space comprises monitoring the at least one non-UE-dedicated search space based at least in part on the updated TCI state.

Aspect 35: The method of any of Aspects 32-34, wherein monitoring the at least one search space comprises monitoring, in at least one monitoring occasion, at least one of a UE-dedicated search space, a non-UE-dedicated search space that is associated with the indicated TCI state, or at least one non-UE-dedicated search space that is not associated with the indicated TCI state.

Aspect 36: The method of Aspect 35, wherein the monitoring TCI state is the indicated TCI state.

Aspect 37: The method of Aspect 35, further comprising receiving a medium access control control element that indicates an updated TCI state, wherein the monitoring TCI state is the updated TCI state.

Aspect 38: The method of any of Aspects 35-37, wherein the monitoring TCI state is based at least in part on at least one of a slot number or a search space configuration.

Aspect 39: The method of any of Aspects 1-38, wherein the at least one search space comprises at least one of a UE-dedicated search space or a non-UE-dedicated search space.

Aspect 40: The method of Aspect 39, wherein the UE-dedicated search space comprises: a UE-specific search space (USS), a type 3 common search space (CS S), or a type 2 CSS.

Aspect 41: The method of either of Aspects 39 or 40, wherein the non-UE-dedicated search space comprises: a type 0 common search space (CSS), a type OA CSS, a type 1 CSS, a type 2 CSS, a type 3 CSS, a search space 0, or a search space associated with a type 0 CORESET.

Aspect 42: The method of any of Aspects 1-41, wherein the at least one search space comprises a non-UE-dedicated search space based at least in part on a monitoring transmission configuration indicator (TCI) state, the method further comprising: receiving a scheduling control channel communication, corresponding to the non-UE-dedicated search space, that schedules a shared channel communication corresponding to a non-UE-dedicated shared channel; and receiving the shared channel corresponding to the non-UE-dedicated shared channel based at least in part on the TCI state.

Aspect 43: The method of Aspect 42, wherein the scheduling control channel communication includes a TCI field that indicates the TCI state.

Aspect 44: The method of Aspect 42, wherein the scheduling control channel communication does not include a TCI field.

Aspect 45: The method of any of Aspects 1-44, wherein monitoring the at least one search space comprises monitoring the at least one search space based at least in part on a control channel repetition configuration.

Aspect 46: The method of Aspect 45, wherein the control channel repetition configuration indicates a link between a type A CORESET of the at least one CORESET and a type C CORESET of the at least one CORESET, wherein the type A CORESET comprises a CORESET of CORESET type A, and wherein the type C CORESET comprises a CORESET of CORESET type C.

Aspect 47: The method of Aspect 45, wherein a link between a type A CORESET of the at least one CORESET and an additional CORESET of the at least one CORESET comprises a link between the type A CORESET and an additional type A CORESET, wherein the type A CORESET comprises a CORESET of CORESET type A.

Aspect 48: A method of wireless communication performed by a user equipment (UE), comprising: receiving an indication of a control resource set (CORESET) configuration of a type 0 CORESET associated with initial network access, wherein the type 0 CORESET is quasi co-located with an initial access reference signal based at least in part on an initial transmission configuration indicator (TCI) state, wherein the initial access reference signal comprises a master information block; and monitoring at least one search space associated with the type 0 CORESET based at least in part on the initial TCI state.

Aspect 49: The method of Aspect 48, wherein the type 0 CORESET is quasi co-located with the initial access reference signal before radio resource control configuration or after a contention free random access channel procedure that is not triggered by a physical downlink control channel order.

Aspect 50: The method of either of Aspects 48 or 49, wherein the initial access reference signal comprises at least one of a physical broadcast channel demodulation reference signal or a synchronization signal block.

Aspect 51: The method of any of Aspects 48-50, further comprising receiving an indication of an indicated TCI state, wherein a TCI state associated with at least one of a UE-dedicated shared channel or a UE-dedicated control channel, prior to receiving the indication, is the initial TCI state.

Aspect 52: The method of any of Aspects 48-51, further comprising performing a random access channel (RACH) procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state.

Aspect 53: The method of any of Aspects 48-52, further comprising: receiving a downlink control information transmission that indicates an indicated TCI state; and receiving a radio resource control configuration that indicates the initial TCI state.

Aspect 54: The method of Aspect 53, wherein the initial TCI state is different than the indicated TCI state.

Aspect 55: The method of Aspect 54, further comprising receiving a medium access control control element (MAC CE) that indicates an updated TCI state associated with the type 0 CORESET.

Aspect 56: The method of Aspect 55, wherein the MAC CE indicates at least one of a channel state information reference signal (CSI-RS) or a synchronization signal block (SSB).

Aspect 57: The method of Aspect 56, wherein monitoring the at least one search space comprises monitoring a type 0 search space for a system information block in a monitoring occasion that is based at least in part on a root SSB corresponding to the CSI-RS.

Aspect 58: The method of Aspect 53, wherein the initial TCI state is the indicated TCI state.

Aspect 59: The method of Aspect 58, wherein monitoring the at least one search space comprises monitoring a type 0 search space for a system information block in a monitoring occasion that is based at least in part on a root synchronization signal block corresponding to a source reference signal associated with the indicated TCI state.

Aspect 60: The method of Aspect 59, wherein the source reference signal comprises at least one of a channel state information reference signal or a tracking reference signal.

Aspect 61: The method of any of Aspects 48-60, wherein the CORESET configuration indicates at least one allowed search space type, of a set of two search space types, associated with the type 0 CORESET, wherein the set of two search space types comprises a UE-dedicated search space type and a non-UE-dedicated search space type.

Aspect 62: The method of Aspect 61, wherein the at least one allowed search space type includes only the non-UE-dedicated search space type.

Aspect 63: The method of Aspect 61, wherein the at least one allowed search space type includes the UE-dedicated search space type, wherein monitoring the at least one search space comprises monitoring, in a monitoring occasion, only one search space type of the at least one allowed search space type.

Aspect 64: The method of Aspect 61, wherein the at least one allowed search space type includes the UE-dedicated search space type, wherein monitoring the at least one search space comprises monitoring, in a monitoring occasion, at least one of a UE-dedicated search space or a non-UE-dedicated search space.

Aspect 65: The method of Aspect 61, wherein the at least one allowed search space type includes the UE-dedicated search space type, wherein a transmission configuration indicator (TCI) state associated with a non-UE-dedicated search space of the at least one search space is also associated with a UE-dedicated CORESET.

Aspect 66: A method of wireless communication performed by a network node, comprising: transmitting an indication of a control resource set (CORESET) configuration that indicates one or more allowed CORESET types, of a set of possible CORESET types, associated with control channel reception corresponding to a component carrier, wherein the set of possible CORESET types comprises: a CORESET type 0, wherein a CORESET having the CORESET type 0 is associated with initial network access; a CORESET type A, wherein a CORESET having the CORESET type A is only associated with UE-dedicated control channel reception; a CORESET type B, wherein a CORESET having the CORESET type B is only associated with non-UE-dedicated control channel reception; and a CORESET type C, wherein a CORESET having the CORESET type C is associated with UE-dedicated control channel reception and non-UE-dedicated control channel reception; and transmitting at least one control channel communication in at least one search space associated with at least one CORESET based at least in part on the CORESET configuration.

Aspect 67: The method of Aspect 66, wherein the one or more allowed CORESET types are the CORESET type 0, the CORESET type A, and the CORESET type B.

Aspect 68: The method of Aspect 66, wherein the one or more allowed CORESET types include the CORESET type C, and wherein the at least one search space is associated with a type C CORESET of the at least one CORESET, wherein the type C CORESET is a CORESET of CORESET type C.

Aspect 69: The method of Aspect 68, wherein the at least one search space comprise once or more search spaces corresponding to a monitoring occasion of the type C CORESET, wherein all of the one or more search spaces are UE-dedicated search spaces or all of the one or more search spaces are non-UE-dedicated search spaces.

Aspect 70: The method of Aspect 68, wherein the at least one search space comprise one or more search spaces corresponding to a monitoring occasion of the type C CORESET, wherein the one or more search spaces comprise at least one of a UE-dedicated search space or a non-UE-dedicated search space.

Aspect 71: The method of Aspect 68, further comprising transmitting an indication of a transmission configuration indicator (TCI) state corresponding to a type A CORESET of the at least one CORESET, wherein the TCI state corresponds to a non-UE-dedicated search space of the at least one search space, and wherein the type A CORESET is a CORESET of type A.

Aspect 72: The method of any of Aspects 66-71, wherein the CORESET configuration corresponds to one of an intercell beam management configuration or an intracell beam management configuration.

Aspect 73: The method of Aspect 72, further comprising transmitting an indication of an additional CORESET configuration that corresponds to the other one of the intercell beam management configuration or the intracell beam management configuration.

Aspect 74: The method of Aspect 66, wherein the one or more allowed CORESET types include the CORESET type C, wherein a type C CORESET of the at least one CORESET is associated with a UE-dedicated search space of the at least one search space, and wherein a monitoring transmission configuration indicator (TCI) state associated with the at least one search space is based at least in part on a per-CORESET determination, wherein the type C CORESET is a CORESET of CORESET type C.

Aspect 75: The method of Aspect 74, further comprising transmitting an indication of an indicated TCI state corresponding to a type A CORESET of the at least one CORESET, wherein the monitoring TCI state comprises the indicated TCI state, wherein the type A CORESET is a CORESET of CORESET type A.

Aspect 76: The method of Aspect 66, wherein the one or more allowed CORESET types include the CORESET type C, wherein a type C CORESET of the at least one CORESET is associated with a non-UE-dedicated search space of the at least one search space, and wherein a monitoring transmission configuration indicator (TCI) state associated with the at least one search space is based at least in part on a per-CORESET determination, wherein the type C CORESET is a CORESET of CORESET type C.

Aspect 77: The method of Aspect 76, further comprising: transmitting an indication of an indicated TCI state corresponding to a type A CORESET of the at least one CORESET, wherein the type A CORESET is a CORESET of CORESET type A; and transmitting an indication of a TCI configuration, wherein the monitoring TCI state is based at least in part on the TCI configuration.

Aspect 78: The method of Aspect 77, wherein the TCI state comprises the indicated TCI state based at least in part on the TCI configuration.

Aspect 79: The method of either of Aspects 77 or 78, wherein transmitting the indication of the TCI configuration comprises transmitting a radio resource control message that includes the indication of the TCI configuration.

Aspect 80: The method of Aspect 66, wherein the one or more allowed CORESET types include the CORESET type C, wherein a type C CORESET of the at least one CORESET is associated with a non-UE-dedicated search space of the at least one search space, and wherein a monitoring transmission configuration indicator (TCI) state associated with the at least one search space is based at least in part on a per-monitoring occasion determination, wherein the type C CORESET is a CORESET of CORESET type C.

Aspect 81: The method of Aspect 80, further comprising: transmitting an indication of an indicated TCI state corresponding to a type A CORESET of the at least one CORESET, wherein the type A CORESET is a CORESET of CORESET type A; and transmitting an indication of a TCI configuration, wherein the monitoring TCI state is based at least in part on the TCI configuration.

Aspect 82: The method of Aspect 81, wherein the monitoring TCI state comprises the indicated TCI state based at least in part on the TCI configuration.

Aspect 83: The method of either of Aspects 81 or 82, wherein transmitting the indication of the TCI configuration comprises transmitting a radio resource control message that includes the indication of the TCI configuration.

Aspect 84: The method of any of Aspects 81-83, wherein the indicated TCI state is associated with the non-UE-dedicated search space, and wherein a plurality of monitoring occasions corresponding to the at least one search space are associated with the type C CORESET based at least in part on the indicated TCI state.

Aspect 85: The method of any of Aspects 81-84, wherein the monitoring TCI state does not include the indicated TCI state.

Aspect 86: The method of Aspect 85, wherein at least one monitoring occasion corresponds to only search spaces of a UE-dedicated search space type and is associated with the indicated TCI state.

Aspect 87: The method of Aspect 85, wherein at least one monitoring occasion corresponds to only search spaces of a non-UE-dedicated search space type, the method further comprising transmitting a medium access control control element that indicates an updated TCI state associated with the at least one monitoring occasion.

Aspect 88: The method of Aspect 85, wherein at least one monitoring occasion corresponds to search spaces of a UE-dedicated search space type and search spaces of a non-UE-dedicated search space type.

Aspect 89: The method of Aspect 88, wherein the monitoring TCI state is the indicated TCI state.

Aspect 90: The method of either of Aspects 88 or 89, further comprising transmitting a medium access control control element that indicates an updated TCI state, wherein the monitoring TCI state is the updated TCI state.

Aspect 91: The method of any of Aspects 85-90, wherein the monitoring TCI state is based at least in part on at least one of a slot number or a search space configuration.

Aspect 92: The method of Aspect 66, wherein the one or more allowed CORESET types include the CORESET type C, wherein a type C CORESET of the at least one CORESET is associated with a non-UE-dedicated search space of the at least one search space, and wherein a monitoring transmission configuration indicator (TCI) state associated with the at least one search space is based at least in part on a per-search-space determination, wherein the type C CORESET is a CORESET of CORESET type C.

Aspect 93: The method of Aspect 92, further comprising: transmitting an indication of an indicated TCI state corresponding to a type A CORESET of the at least one CORESET, wherein the type A CORESET is a CORESET of CORESET type A; and transmitting an indication of a TCI configuration, wherein the monitoring TCI state is based at least in part on the TCI configuration.

Aspect 94: The method of Aspect 93, wherein the monitoring TCI state comprises the indicated TCI state based at least in part on the TCI configuration.

Aspect 95: The method of either of Aspects 93 or 94, wherein transmitting the indication of the TCI configuration comprises transmitting a radio resource control message that includes the indication of the TCI configuration.

Aspect 96: The method of any of Aspects 93-95, wherein the indicated TCI state is associated with all non-UE-dedicated search spaces of the at least one search space, and wherein a plurality of monitoring occasions corresponding to the type C CORESET are associated with the indicated TCI state.

Aspect 97: The method of any of Aspects 93-95, wherein the indicated TCI state is not associated with at least one non-UE-dedicated search space of the at least one search space.

Aspect 98: The method of Aspect 97, wherein the indicated TCI state is associated with at least one monitoring occasion corresponding to at least one of a UE-dedicated search space or a non-UE-dedicated search space associated with the indicated TCI state.

Aspect 99: The method of Aspect 97, further comprising transmitting a medium access control control element that indicates an updated TCI state associated with at least one monitoring occasion corresponding to at least one non-UE-dedicated search space that is not associated with the indicated TCI state.

Aspect 100: The method of Aspect 97, wherein at least one monitoring occasion corresponds to at least one of a UE-dedicated search space, a non-UE-dedicated search space that is associated with the indicated TCI state, or at least one non-UE-dedicated search space that is not associated with the indicated TCI state.

Aspect 101: The method of Aspect 100, wherein the monitoring TCI state is the indicated TCI state.

Aspect 102: The method of Aspect 100, further comprising transmitting a medium access control control element that indicates an updated TCI state, wherein the monitoring TCI state is the updated TCI state.

Aspect 103: The method of any of Aspects 100-102, wherein the monitoring TCI state is based at least in part on at least one of a slot number or a search space configuration.

Aspect 104: The method of any of Aspects 66-103, wherein the at least one search space comprises at least one of a UE-dedicated search space or a non-UE-dedicated search space.

Aspect 105: The method of Aspect 104, wherein the UE-dedicated search space comprises: a UE-specific search space (USS), a type 3 common search space (CSS), or a type 2 CSS.

Aspect 106: The method of either of Aspects 104 or 105, wherein the non-UE-dedicated search space comprises: a type 0 common search space (CSS), a type OA CSS, a type 1 CSS, a type 2 CSS, a type 3 CSS, a search space 0, or a search space associated with a type 0 CORESET.

Aspect 107: The method of Aspect 66, wherein the at least one search space comprises a non-UE-dedicated search space based at least in part on a monitoring transmission configuration indicator (TCI) state, the method further comprising: transmitting a scheduling control channel communication, corresponding to the non-UE-dedicated search space, that schedules a shared channel communication corresponding to a non-UE-dedicated shared channel; and transmitting the shared channel corresponding to the non-UE-dedicated shared channel based at least in part on the TCI state.

Aspect 108: The method of Aspect 107, wherein the scheduling control channel communication includes a TCI field that indicates the TCI state.

Aspect 109: The method of Aspect 107, wherein the scheduling control channel communication does not include a TCI field.

Aspect 110: The method of any of Aspects 66-109, wherein the at least one search space corresponds to a control channel repetition configuration.

Aspect 111: The method of Aspect 110, wherein the control channel repetition configuration indicates a link between a type A CORESET of the at least one CORESET and a type C CORESET of the at least one CORESET, wherein the type A CORESET comprises a CORESET of CORESET type A, and wherein the type C CORESET comprises a CORESET of CORESET type C.

Aspect 112: The method of Aspect 110, wherein a link between a type A CORESET of the at least one CORESET and an additional CORESET of the at least one CORESET comprises a link between the type A CORESET and an additional type A CORESET, wherein the type A CORESET comprises a CORESET of CORESET type A.

Aspect 113: A method of wireless communication performed by a network node, comprising: transmitting an indication of a control resource set (CORESET) configuration of a type 0 CORESET associated with initial network access, wherein the type 0 CORESET is quasi co-located with an initial access reference signal based at least in part on an initial transmission configuration indicator (TCI) state, wherein the initial access reference signal comprises a master information block; and transmitting at least one control channel communication in at least one search space associated with the type 0 CORESET based at least in part on the initial TCI state.

Aspect 114: The method of Aspect 113, wherein the type 0 CORESET is quasi co-located with the initial access reference signal before radio resource control configuration or after a contention free random access channel procedure that is not triggered by a physical downlink control channel order.

Aspect 115: The method of either of Aspects 113 or 114, wherein the initial access reference signal comprises at least one of a physical broadcast channel demodulation reference signal or a synchronization signal block.

Aspect 116: The method of any of Aspects 113-115, further comprising transmitting an indication of an indicated TCI state, wherein a TCI state associated with at least one of a UE-dedicated shared channel or a UE-dedicated control channel, prior to receiving the indication, is the initial TCI state.

Aspect 117: The method of any of Aspects 113-116, further comprising performing a random access channel (RACH) procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state.

Aspect 118: The method of any of Aspects 113-117, further comprising: transmitting a downlink control information transmission that indicates an indicated TCI state; and transmitting a radio resource control configuration that indicates the initial TCI state.

Aspect 119: The method of Aspect 118, wherein the initial TCI state is different than the indicated TCI state.

Aspect 120: The method of Aspect 119, further comprising transmitting a medium access control control element (MAC CE) that indicates an updated TCI state associated with the type 0 CORESET.

Aspect 121: The method of Aspect 120, wherein the MAC CE indicates at least one of a channel state information reference signal (CSI-RS) or a synchronization signal block (SSB).

Aspect 122: The method of Aspect 121, further comprising transmitting a system information block in a type 0 search space of the at least one search space, wherein a monitoring occasion corresponding to the type 0 search space is based at least in part on a root SSB corresponding to the CSI-RS.

Aspect 123: The method of any of Aspects 118-122, wherein the initial TCI state is the indicated TCI state.

Aspect 124: The method of Aspect 123, further comprising transmitting a system information block in a type 0 search space, wherein a monitoring occasion corresponding to the type 0 search space is based at least in part on a root synchronization signal block corresponding to a source reference signal associated with the indicated TCI state.

Aspect 125: The method of Aspect 124, wherein the source reference signal comprises at least one of a channel state information reference signal or a tracking reference signal.

Aspect 126: The method of any of Aspects 113-125, wherein the CORESET configuration indicates at least one allowed search space type, of a set of two search space types, associated with the type 0 CORESET, wherein the set of two search space types comprises a UE-dedicated search space type and a non-UE-dedicated search space type.

Aspect 127: The method of Aspect 126, wherein the at least one allowed search space type includes only the non-UE-dedicated search space type.

Aspect 128: The method of Aspect 126, wherein the at least one allowed search space type includes the UE-dedicated search space type, and wherein a monitoring occasion corresponds to only one search space type of the at least one allowed search space type.

Aspect 129: The method of Aspect 126, wherein the at least one allowed search space type includes the UE-dedicated search space type, and wherein a monitoring occasion corresponds to at least one of a UE-dedicated search space or a non-UE-dedicated search space.

Aspect 130: The method of Aspect 126, wherein the at least one allowed search space type includes the UE-dedicated search space type, wherein a transmission configuration indicator (TCI) state associated with a non-UE-dedicated search space of the at least one search space is also associated with a UE-dedicated CORESET.

Aspect 131: An apparatus for wireless communication at a device, comprising a processor; memory coupled with the processor; and instructions stored in the memory and executable by the processor to cause the apparatus to perform the method of one or more of Aspects 1-130.

Aspect 132: A device for wireless communication, comprising a memory and one or more processors coupled to the memory, the one or more processors configured to perform the method of one or more of Aspects 1-130.

Aspect 133: An apparatus for wireless communication, comprising at least one means for performing the method of one or more of Aspects 1-130.

Aspect 134: A non-transitory computer-readable medium storing code for wireless communication, the code comprising instructions executable by a processor to perform the method of one or more of Aspects 1-130.

Aspect 135: A non-transitory computer-readable medium storing a set of instructions for wireless communication, the set of instructions comprising one or more instructions that, when executed by one or more processors of a device, cause the device to perform the method of one or more of Aspects 1-130.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a control resource set (CORESET) configuration that indicates one or more allowed CORESET types, of a set of possible CORESET types, associated with control channel reception corresponding to a component carrier, wherein the set of possible CORESET types comprises:
a CORESET type 0, wherein a CORESET having the CORESET type 0 is associated with initial network access;
a CORESET type A, wherein a CORESET having the CORESET type A is only associated with UE-dedicated control channel reception;
a CORESET type B, wherein a CORESET having the CORESET type B is only associated with non-UE-dedicated control channel reception; and
a CORESET type C, wherein a CORESET having the CORESET type C is associated with UE-dedicated control channel reception and non-UE-dedicated control channel reception; and
monitor at least one search space associated with at least one CORESET based at least in part on the CORESET configuration.

2. The UE of claim 1, wherein the one or more allowed CORESET types are the CORESET type 0, the CORESET type A, and the CORESET type B.

3. The UE of claim 1, wherein the one or more allowed CORESET types include the CORESET type C, and wherein the at least one search space is associated with a type C CORESET of the at least one CORESET, wherein the type C CORESET is a CORESET of CORESET type C.

4. The UE of claim 3, the one or more processors, to monitor the at least one search space, are configured to monitor, in a monitoring occasion of the type C CORESET, one or more search spaces of the at least one search space, wherein all of the one or more search spaces are UE-dedicated search spaces or all of the one or more search spaces are non-UE-dedicated search spaces.

5. The UE of claim 3, the one or more processors, to monitor the at least one search space, are configured to monitor, in a monitoring occasion of the type C CORESET, one or more search spaces of the at least one search space, wherein the one or more search spaces comprise at least one of a UE-dedicated search space or a non-UE-dedicated search space.

6. The UE of claim 1, wherein the one or more allowed CORESET types include the CORESET type C, wherein a type C CORESET of the at least one CORESET is associated with a non-UE-dedicated search space of the at least one search space, and the one or more processors, to monitor the at least one search space, are configured to monitor the at least one search space based at least in part on a per-CORESET determination of a monitoring transmission configuration indicator (TCI) state, wherein the type C CORESET is a CORESET of CORESET type C.

7. The UE of claim 6, wherein the one or more processors are further configured to:
receive an indication of an indicated TCI state corresponding to a type A CORESET of the at least one CORESET, wherein the type A CORESET is a CORESET of CORESET type A; and
receive an indication of a TCI configuration, wherein the monitoring TCI state is based at least in part on the TCI configuration.

8. The UE of claim 7, wherein the TCI state comprises the indicated TCI state based at least in part on the TCI configuration.

9. The UE of claim 7, wherein the one or more processors, to receive the indication of the TCI configuration, are configured to receive a radio resource control message that includes the indication of the TCI configuration.

10. A user equipment (UE) for wireless communication, comprising:
a memory; and
one or more processors, coupled to the memory, configured to:
receive an indication of a control resource set (CORESET) configuration of a type 0 CORESET associated with initial network access, wherein the type 0 CORESET is quasi co-located with an initial access reference signal based at least in part on an initial transmission configuration indicator (TCI) state, wherein the initial access reference signal comprises a master information block; and
monitor at least one search space associated with the type 0 CORESET based at least in part on the initial TCI state.

11. The UE of claim 10, wherein the type 0 CORESET is quasi co-located with the initial access reference signal before radio resource control configuration or after a contention free random access channel procedure that is not triggered by a physical downlink control channel order.

12. The UE of claim 10, wherein the initial access reference signal comprises at least one of a physical broadcast channel demodulation reference signal or a synchronization signal block.

13. The UE of claim 10, wherein the one or more processors are further configured to receive an indication of an indicated TCI state, wherein a TCI state associated with at least one of a UE-dedicated shared channel or a UE-dedicated control channel, prior to receiving the indication, is the initial TCI state.

14. The UE of claim 10, wherein the one or more processors are further configured to perform a random access channel (RACH) procedure that is not triggered by a physical downlink control channel order, wherein the initial access reference signal comprises a synchronization signal block associated with the RACH procedure, and wherein a TCI state associated with at least one of a UE-dedicated shared channel or a UE-dedicated control channel, after performing the RACH procedure, is the initial TCI state.

15. The UE of claim 10, wherein the one or more processors are further configured to:
receive a downlink control information transmission that indicates an indicated TCI state; and
receive a radio resource control configuration that indicates the initial TCI state.

16. The UE of claim 15, wherein the initial TCI state is different than the indicated TCI state.

17. The UE of claim 16, wherein the one or more processors are further configured to receive a medium access control control element (MAC CE) that indicates an updated TCI state associated with the type 0 CORESET.

18. The UE of claim 17, wherein the MAC CE indicates at least one of a channel state information reference signal (CSI-RS) or a synchronization signal block (SSB).

19. The UE of claim 18, wherein the one or more processors, to monitor the at least one search space, are configured to monitor a type 0 search space for a system information block in a monitoring occasion that is based at least in part on a root SSB corresponding to the CSI-RS.

20. The UE of claim 15, wherein the initial TCI state is the indicated TCI state.

21. The UE of claim 20, wherein the one or more processors, to monitor the at least one search space, are configured to monitor a type 0 search space for a system information block in a monitoring occasion that is based at least in part on a root synchronization signal block corresponding to a source reference signal associated with the indicated TCI state.

22. The UE of claim 21, wherein the source reference signal comprises at least one of a channel state information reference signal or a tracking reference signal.

23. A method of wireless communication performed by a user equipment (UE), comprising:
receiving an indication of a control resource set (CORESET) configuration that indicates one or more allowed CORESET types, of a set of possible CORESET types, associated with control channel reception corresponding to a component carrier, wherein the set of possible CORESET types comprises:
a CORESET type 0, wherein a CORESET having the CORESET type 0 is associated with initial network access;
a CORESET type A, wherein a CORESET having the CORESET type A is only associated with UE-dedicated control channel reception;
a CORESET type B, wherein a CORESET having the CORESET type B is only associated with non-UE-dedicated control channel reception; and
a CORESET type C, wherein a CORESET having the CORESET type C is associated with UE-dedicated control channel reception and non-UE-dedicated control channel reception; and
monitoring at least one search space associated with at least one CORESET based at least in part on the CORESET configuration.

24. The method of claim 23, wherein the one or more allowed CORESET types are the CORESET type 0, the CORESET type A, and the CORESET type B.

25. The method of claim 23, wherein the one or more allowed CORESET types include the CORESET type C, and wherein the at least one search space is associated with a type C CORESET of the at least one CORESET, wherein the type C CORESET is a CORESET of CORESET type C.

26. The method of claim 25, wherein monitoring the at least one search space comprises monitoring, in a monitoring occasion of the type C CORESET, one or more search spaces of the at least one search space, wherein the one or more search spaces comprise at least one of a UE-dedicated search space or a non-UE-dedicated search space.

27. The method of claim 23, wherein the one or more allowed CORESET types include the CORESET type C, wherein a type C CORESET of the at least one CORESET is associated with a non-UE-dedicated search space of the at least one search space, and wherein monitoring the at least one search space comprises monitoring the at least one search space based at least in part on a per-CORESET determination of a monitoring transmission configuration indicator (TCI) state, wherein the type C CORESET is a CORESET of CORESET type C.

28. A method of wireless communication performed by a user equipment (UE), comprising:
receiving an indication of a control resource set (CORESET) configuration of a type 0 CORESET associated with initial network access, wherein the type 0 CORESET is quasi co-located with an initial access reference signal based at least in part on an initial transmission configuration indicator (TCI) state, wherein the initial access reference signal comprises a master information block; and
monitoring at least one search space associated with the type 0 CORESET based at least in part on the initial TCI state.

29. The method of claim 28, wherein the type 0 CORESET is quasi co-located with the initial access reference signal before radio resource control configuration or after a contention free random access channel procedure that is not triggered by a physical downlink control channel order.

30. The method of claim 28, wherein the initial access reference signal comprises at least one of a physical broadcast channel demodulation reference signal or a synchronization signal block.
